(19) United States
(12) Patent Application Publication
(10) Pub. No.: US 2019/0220929 A1
(43) Pub. Date: Jul. 18, 2019

(54) METHODS AND SYSTEMS FOR ESTIMATING OPTION GREEKS

(71) Applicant: FinancialCAD Corporation, Surrey (CA)

(72) Inventors: Russell GOYDER, Coquitlam (CA); Mark John GIBBS, Mill Bay (CA); Glen GOODVIN, Vancouver (CA)

(21) Appl. No.: 16/251,006

(22) Filed: Jan. 17, 2019

Related U.S. Application Data
(60) Provisional application No. 62/618,610, filed on Jan. 17, 2018.

(51) Int. Cl. G06Q 40/06; G06F 17/13

(52) U.S. Cl. CPC G06Q 40/06; G06F 17/13

(57) ABSTRACT

Methods determine a representation of the option Greek delta Δ which expresses a dependence of an expected value V of a financial contract on one or more underlyings of the financial contract/ The method comprises obtaining: a complete set of algorithmic differentiation (AD) sensitivities of the expected value of the financial contract to a set of N input parameters \vec{a} in a form

$$\vec{∇} V = {[ \frac{\partial V}{\partial {a}_{1}} , \frac{\partial V}{\partial {a}_{2}} , … \frac{\partial V}{\partial {a}_{N}} ]}^{T} ;$$

and a complete set of AD sensitivities of the expected value of the one or more underlyings Fⱼ for j=1 . . . M, where M<N and M is a number of the one or more underlyings to the set of N input parameters \vec{a} in a form

$$\vec{∇} {F}_{j} = {[ \frac{\partial {F}_{j}}{\partial {a}_{1}} , \frac{\partial {F}_{j}}{\partial {a}_{2}} , … \frac{\partial {F}_{j}}{\partial {a}_{N}} ]}^{T}$$

for each j=1 . . . M. The method then reprojects the full set of AD sensitivities \vec{∇}V onto the full set of AD sensitivities \vec{∇}Fⱼ for j=1 . . . M to obtain reprojected sensitivity vectors and determines the parameter delta Δ from the reprojected sensitivity vectors.

### RELATED APPLICATIONS

This application claims the benefit under 35 USC 119 of U.S. application No. 62/618,610 filed 17 Jan. 2018, which is hereby incorporated herein by reference.

### FIELD

This invention relates to systems and methods for valuating financial contracts and, in particular, for estimating and evaluating metrics used to characterize such contracts.

### BACKGROUND

There is a desire to value financial contracts. Some financial contracts are relatively simple. Simple contracts can be relatively easy to value. For example, a contract where party A loans party B US $100 today and party B agrees to pay back the US $100 plus 5% interest in 1 year may be viewed (from the perspective of party A) as a cash outflow of US $100 at time t=0 and a cash inflow of US $105 at a time t=1 year. The present value of a such future cash flow can be valued according to the well known present value equation

$$NPV = {\sum }_{t = 1}^{T} \frac{{R}_{t}}{{( 1 + r )}^{t}} - {R}_{0}$$

where: R₀ is the initial investment at time t=0; t is a time of a cash flow; Rₜ is the amount of the cash flow at time t (positive for incoming cash flows and negative for outgoing cash flows); T is the time horizon under consideration; and r is the discount rate. If the net present value (NPV) of a contract is NPV>0, then it would be an attractive contract; if NPV<0, then the contract is unattractive; and if the NPV=0, then a party would be indifferent to the contract.

In the example case described above, the initial investment is R₀=$100 and the return at t=T=1 year is R₁=$105. Assuming that party A can borrow the US $100 at the same 5% rate, then the discount rate r in the net present value (NPV) equation set out above may be set to r=0.05 which results in NPV=0. This is expected, since party A would be indifferent to receiving $105 in 1 year if it also had to pay back $105 in 1 year. However, if party A could borrow money at 4%, the discount rate r in the above NPV equation may be set to r=0.04. Assuming that party A could still arrange a contract with party B to loan party B $100 today and to receive $105 in a year, then the NPV of such a contract would NPV=$0.96 which makes the contract attractive to party A.

The NPV of the contract does not tell the whole story, however, as the NPV assumes that certain market data is fixed. For example, the example case described above assumes that the rate at which party A can borrow money is fixed for the entire year and this assumption is reflected in the constant discount rate r. In reality, however, market data can fluctuate and there is associated risk that the NPV of a financial contract can vary with fluctuations in market data. For example, the rate at which party A is paying interest on borrowed money (which is used for the discount rate r in the NPV equation set out above) could increase in middle of the contract. In addition to the NPV of a contract, it is therefore desirable to know the dependence of the NPV on changes to market data.

Prior art methods for characterizing the sensitivity of financial contracts to underlying parameters include the so-called “Greeks”, also referred to as hedge parameters and/or risk sensitivities. The Greeks are metrics used to characterize financial contracts and have become accepted metrics used by traders in complex financial transactions involving options and other, often more complex, derivatives. The Greeks frame traders' intuition for how financial contracts behave. A number of Greeks used by traders include delta (Δ), vega (sometimes referenced using the Greek letter nu (ν)), theta (θ), rho (ρ) and gamma (Γ).

Consider a financial contract with a value V that depends on an underlying. By way of non-limiting example, the underlying could be a stock price, an interest rate, a FX rate, a commodity price, and/or the like. Delta is a metric which describes the rate of change of the theoretical contract value V with respect to changes in the price (S) of an underlying. According to prior art techniques, delta is the derivative of the contract value V with respect to the price S. Vega describes the sensitivity of the value V of the financial contract to the volatility (σ) of the underlying. According to prior art techniques, vega is the derivative of the option value V with respect to the volatility σ of the underlying. Theta is a metric which describes the sensitivity of the value V of the contract to the passage of time (τ). According to prior art techniques, vega is the derivative of the option value V with respect to time τ. Rho is a metric representative of the sensitivity of the value V of the financial contract to the risk free interest rate r. According to prior art techniques, vega is the derivative of the contract value V with respect to the interest rate r. Gamma is the derivative of the delta (Δ) with respect to the price S.

The Greeks are typically presented in clean, theoretical frameworks, such as the Black-Scholes model. For example, consider the delta of a European call option in the Black-Scholes model:

$$\begin{matrix}{Δ}_{BS} ≡ \frac{\partial }{\partial {S}_{0}} {\vert}_{r , σ} ( {S}_{0} Φ ( {d}_{1} ) {Ke}^{- rT} Φ ( {d}_{2} ) ) = Φ ( {d}_{1} ) & ( 1 ) \\ {d}_{1} = \frac{1}{σ \sqrt{T}} [ ln ( \frac{{S}_{0}}{K} ) + ( r + \frac{{σ}^{2}}{2} ) T ] & ( 2 )\end{matrix}$$

d₂=d₁−σ\sqrt{T}, where S₀ is the today's price of the underlying, K is the strike price, T is the strike date, r is the risk free interest rate, σ is the volatility of the underlying and Φ(⋅) is the cumulative standard normal distribution function. The situation of equations (1) and (2) is theoretically stylized.

Real derivatives are often much more complex, with sensitivities to quotes used to build curves and calibrate models, and also to parameters that encode modeling assumptions where sufficiently liquid quotes are not available for calibration. In reality, there is no “risk free rate” r, and instead discount and interest rate curves may be implied from instruments such as futures and swaps. Equation (1) ignores dividends, which are often represented as a continuous dividend rate q. Typically, however, such a continuous dividend rate q is often unavailable. A more typical practical scenario for real derivatives might involve the use of a forward curve with its own modeling assumptions, likely based on a funding rate which is distinct from r, and which may involve continuous or discrete dividend modeling, may have been calibrated or implied somehow from option prices, and which is fundamentally a daily stepping function, not a continuous function of time, and therefore not strictly differentiable. In addition, real options can have settlement delays between expiry and delivery, so the time in σ\sqrt{T} isn't necessarily the same time as that which should be used when discounting.

For diverse portfolios, the collection of sensitivities can number hundreds or even thousands.

A number of these issues can be addressed by moving to the Black model and working in forward space instead of calculating delta as the change in present value of the financial contract for a given change in the underlying price S, we can form delta as the change in at-expiry option value for a given change in at-expiry forward value of the underlying

$${F}_{T} = {S}_{0} {e}^{rT} ,$$

$${Δ}_{B} = \frac{\partial }{\partial {F}_{T}} {\vert}_{σ} [ {F}_{T} Φ ( {d}_{1} ) - K Φ ( {d}_{2} ) ] = Φ ( {d}_{1} ) \qquad ( 3 )$$

where d₁ in terms of F_{T} is given by

$${d}_{1} = \frac{1}{σ \sqrt{T}} [ ln ( \frac{{F}_{T}}{K} ) + \frac{{σ}^{2}}{2} T ] \qquad ( 4 )$$

In the formulation of equations (3) and (4), all of the details of constructing a forward curve are abstracted away in the function F_{T} which, when evaluated at the appropriate time, gives the forward value. While in the example of equations (1)-(4), the Black-Scholes model has simply been replaced with the Black model, it remains true for European option prices in all models that, by working with the at-expiry forward price of the underlying, details of funding and dividend modeling disappear from the formulae, which remain valid even in the presence of stochastic interest rates. In this sense, the forward price, not spot price, is the true underlying of an option.

Formulae like equation (3) are typically used by traders to understand the behavior and market risk of financial contracts. Therefore, it is commonplace in prior art systems which attempt to estimate the value of, or otherwise model, financial contracts to also provide the formulae for corresponding Greeks. Using such formulae to estimate the Greeks is a computationally expensive endeavor, however. Real-world financial contract pricing analytics span various dimensions, including, without limitation option underlyings: equity, FX, interest rates, swaps, swap rates, inflation, spreads, baskets, averages (Asian options);
payoff types: call, put, digital, many types of strategies, such as risk reversal, butterfly;
exercise styles: European, Bermudan, American;
contingent factors: barriers, triggers;
valuation methods: closed-form, Monte Carlo, static portfolio replication, trees, PDEs;
models: numerous parametric and non-parametric local volatility, stochastic volatility, stochastic-local volatility models.
   The combinatorics implied by these factors generates a vast number of possible option pricers and corresponding complexity associated with setting up a model (e.g. performing mathematical analysis and programming corresponding software code) which is capable of reliably estimating the Greeks for each special circumstance.

There is a general desire for methods and/or systems that reduce the complexity associated with setting up a computational model that can reliably estimate the Greeks associated with financial contracts and/or other parameters for characterizing the sensitivity of financial contracts to underlying parameters.

### SUMMARY

One aspect of the invention provides a method for determining a parameter delta Δ which expresses a dependence of an expected value V of a financial contract on one or more underlyings of the financial contract. The method comprises: obtaining a complete set of algorithmic differentiation (AD) sensitivities of the expected value of the financial contract to a set of N input parameters \vec{a} in a form

$$\vec{∇} V = {[ \frac{\partial V}{\partial {a}_{1}} , \frac{\partial V}{\partial {a}_{2}} , … \frac{\partial V}{\partial {a}_{N}} ]}^{T}$$

or a mathematical equivalent thereof; obtaining a complete set of AD sensitivities of the expected value of the one or more underlyings Fⱼ for j=1 . . . M, where M<N and M is a number of the one or more underlyings to the set of N input parameters \vec{a} in a form

$$\vec{∇} {F}_{j} = {[ \frac{\partial {F}_{j}}{\partial {a}_{1}} , \frac{\partial {F}_{j}}{\partial {a}_{2}} , … \frac{\partial {F}_{j}}{\partial {a}_{N}} ]}^{T}$$

for each j=1 . . . M or a mathematical equivalent thereof; reprojecting the full set of AD sensitivities \vec{∇}V of the expected value of the financial contract onto the full set of AD sensitivities \vec{∇}Fⱼ for j=1 . . . M of the one or more underlyings to obtain reprojected sensitivity vectors; and determining the parameter delta Δ from the reprojected sensitivity vectors.

Reprojecting the full set of AD sensitivities \vec{∇}V of the expected value of the financial contract onto the full set of AD sensitivities \vec{∇}Fⱼ for j=1 . . . M of the one or more underlyings to obtain reprojected sensitivity vectors may comprise decomposing the full set of AD sensitivities \vec{∇}V of the expected value of the financial contract into a pair of orthogonal reprojected sensitivity vectors.

Decomposing the full set of AD sensitivities \vec{∇}V of the expected value of the financial contract into the pair of orthogonal reprojected sensitivity vectors may comprise: decomposing the full set of AD sensitivities \vec{∇}V of the expected value of the financial contract into the pair of orthogonal reprojected sensitivity vectors comprising J^{T}\vec{Δ}=Σⱼ₌₁^{M}Δⱼ\vec{∇}Fⱼ and \vec{ν}, where the j^{th} column of J^{T} is \vec{∇}Fⱼ; and selecting the Δⱼ to minimize |\vec{ν}|.

Selecting the Δⱼ to minimize WI may comprise performing linear regression which minimizes \vec{ν}·\vec{ν}.

Determining the parameter delta Δ from the reprojected sensitivity vectors comprises determining the parameter delta Δ in accordance with Δ=Σⱼ₌₁^{M}Δⱼ.

Where the number M of underlyings is M=1, decomposing the full set of AD sensitivities \vec{∇}V of the expected value of the financial contract into the pair of orthogonal reprojected sensitivity vectors may comprise: decomposing the full set of AD sensitivities \vec{∇}V of the expected value of the financial contract into the pair of orthogonal reprojected sensitivity vectors comprising Δⱼ\vec{∇}Fⱼ and \vec{ν}; and selecting

$${Δ}_{1} = \frac{\vec{∇} {F}_{1} \cdot \vec{∇} V}{{\vert \vec{∇} {F}_{1} \vert}^{2}} .$$

Determining the parameter delta Δ from the reprojected sensitivity vectors where M=1 may comprise determining the parameter delta Δ in accordance with Δ=Δ₁.

The method may comprise determining a direction of the reprojected sensitivity vector J^{T}\vec{Δ}=Σⱼ₌₁^{M}Δⱼ\vec{∇}Fⱼ.

Determining the direction of the reprojected sensitivity vector J^{T}\vec{Δ}=Σⱼ₌₁^{M}Δⱼ\vec{∇}Fⱼ may comprise determining a unit vector \vec{e}_{Δ} in the direction of the reprojected sensitivity vector J^{T}\vec{Δ}=Σⱼ₌₁^{M}Δⱼ\vec{∇}Fⱼ.

The method may further comprise determining a parameter vega ν which expresses a dependence of the expected value V of the financial contract to any volatilities which may be present in the one or more underlyings based at least in part on the reprojected sensitivity vectors.

The method may further comprise determining a parameter vega ν which expresses a dependence of the expected value V of the financial contract to the any volatilities which may be present in the one or more underlyings according to ν=(\vec{ν}·\vec{ν})^{1/2}.

The method may comprise determining that the parameter vega ν is zero and outputting an indication that the financial contract does not have optionality and/or determining that the parameter vega ν is non-zero and outputting an indication that the financial contract does have optionality.

The method may further comprise determining a parameter gamma Γ which expresses a dependence of the parameter delta Δ on the one or more underlyings of the financial contract wherein determining a parameter gamma Γ comprises applying a finite difference technique using the full set of AD sensitivities \vec{∇}V of the expected value of the financial contract.

Determining a parameter gamma Γ may comprise applying a finite difference technique using the full set of AD sensitivities \vec{∇}V of the expected value of the financial contract. Applying the finite difference technique using the full set of AD sensitivities \vec{∇}V of the expected value of the financial contract may comprise: forming a displaced market vector \vec{a}′ according to \vec{a}′=\vec{a}+δa\vec{e}_{Δ} where δa is a finite difference magnitude and \vec{e}_{Δ} is a unit vector having a direction of the reprojected sensitivity vector

$${J}^{T} \vec{Δ} = {\sum }_{j = 1}^{M} {Δ}_{j} \vec{∇} {F}_{j} ( {\vec{e}}_{Δ} = \frac{{J}^{T} \vec{Δ}}{\vert {J}^{T} \vec{Δ} \vert} ≡ \frac{{\sum }_{j = 1}^{M} {Δ}_{j} \vec{∇} {F}_{j}}{\vert {\sum }_{j = 1}^{M} {Δ}_{j} \vec{∇} {F}_{j} \vert} ) ;$$

obtaining a full set of displaced AD sensitivities \vec{∇}V(\vec{a}′) of the expected value of the financial contract at the displaced market vector \vec{a}′; determining a maximal gamma vector \vec{Γ} according to

$$\vec{Γ} = \frac{\vec{∇} v ( {\vec{a}}^{′} ) - \vec{∇} v}{δ a} ;$$

and determining the parameter gamma Γ according to

$$Γ = \frac{{( \vec{Γ} \cdot \vec{Γ} )}^{\frac{1}{2}}}{δ a} .$$

Some or all of the method steps may be performed by one or more suitably configured processors.

Another aspect of the invention comprises a system for determining a parameter delta Δ which expresses a dependence of an expected value V of a financial contract on one or more underlyings of the financial contract, where the system comprises one or more processors configured to perform any of the methods disclosed herein.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 schematically illustrates an example reprojection of a full set of sensitivities of a financial contract (in a sensitivity space [symbol] having a dimensionality, in the illustrated example, of N=3) onto an underlying sensitivity subspace [symbol] (having a dimensionality, in the illustrated example, of M=2).

FIG. 2 shows the geometry of the application of obtaining a generalized delta and vega in a method comprising sensitivity reprojection techniques (e.g. as shown in FIG. 1) for a European call option modelled according to the Black-Scholes model.

FIG. 3 shows the deviation of delta for a quanto option (Δ_{Q}) determined according to a method comprising sensitivity reproduction techniques (e.g. as shown in FIG. 1) from commonly used quanto delta (Δ_{B}′) for a number of FX volatilities (i.e. for a number of σ_{X} values).

FIGS. 4A and 4B show the deviation of vega for a quanto option (|\vec{ν_{Q}}|) determined according to a method comprising sensitivity reproduction techniques (e.g. as shown in FIG. 1) from commonly used quanto vega (ν_{B}′) as a function of correlation ρ for a number of FX volatilities (i.e. for a number of σ_{X} values) and for σ=10% (FIG. 4A) and σ=50% (FIG. 4B).

FIG. 5 shows various annuity-scaled swaption deltas

$$( \frac{Δ}{A} )$$

as a function of moneyness (i.e. a ratio of the strike over the swap rate

$$( \frac{K}{s} ) )$$

and illustrates the correction of the delta obtained using according to a method comprising sensitivity reproduction techniques (e.g. as shown in FIG. 1) relative to the delta obtained from commonly used techniques.

FIGS. 6A, 6B and 6C show a flowchart depiction of a method for determining the option greeks delta, gamma and vega according to a particular embodiment.

FIGS. 7A and 7B respectively show flowchart depictions of methods for determining the gamma vector (\vec{Γ}) for the case with a single underlying and the case for multiple underlyings according to particular embodiments.

FIGS. 8A and 8B show a flowchart depiction of a method for determining the option greeks delta, gamma, vega and rho according to a particular embodiment.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

### Computer-Implemented Financial Models, Contract Representations and AD Sensitivities

The methods described in this application have application to the modelling of financial contracts and may be provided by or as a part of computer-implemented software for modeling financial contracts. Such financial contracts frequently contain options and/or other financial derivatives and, consequently, the financial contract modelling software which models such contracts may be referred to colloquially as “option pricing software” (or, an “option pricer”) because such software predicts the current value (or price) of financial contracts.

Where “clean” analytical formulae like equation (3) are not available, prior art option pricers typically use so-called “finite difference” techniques to estimate (by numerical computation) derivatives of various parameters in a financial model and corresponding differential equations. As the name of the technique suggests, such finite difference methods replace the calculus concept of the infinitesimal with discrete finite differences.

Recently, however, option pricers have begun to incorporate software-implemented Algorithmic Differentiation (AD) techniques. Software-implemented AD comprises a set of software tools that evaluate the derivatives of functions algebraically, typically by repeated application of the chain rule. Option pricers which make use of AD include the software marketed under the brands FINCAD and F3 by FinancialCAD Corporation. The use of AD in option pricing software is described, for example, in Gibbs, M. & Goyder, R. Universal Algorithmic Differentiation in the F3 Platform. Tech. Rep., FINCAD (2014). http://www.fincad.com/resources/resource-library/whitepaper/universal-algorithmic-differentiation-f3-platform (which is incorporated herein by reference).

The use of AD to model financial contracts makes available a complete set of partial derivatives for a financial model with respect to each of the parameters in the parameter set of the model, with respect to market quotes that form part of the market data used by the model, with respect to other models, further partial derivatives of any of these derivatives with respect to their parameters and/or the like. By way of non-limiting examples, such partial derivatives may include partial derivatives with respect to swap, futures and cash deposit quotes (which may be used to construct a discount curve), with respect to each discrete dividend assumption and any parameters used to model funding, with respect to each volatility quote (which may be used to construct a volatility input σ), and/or the like. Such a complete set of partial derivatives may be referred to herein as the complete set of AD sensitivities. AD functionality of the type used in these option pricers produces a complete set of AD sensitivities with relatively low burden when compared to finite difference approaches.

Consider an arbitrary contract with value V(\vec{a}) depending on a collection of N input parameters [a₁, a₂, . . . a_{N}] represented by the vector \vec{a}. These input parameters \vec{a} may include any suitable parameters, including, for example, market quotes, which may feed calibrations. The full set of AD sensitivities for this contract may be given by:

$$dV = {\sum }_{i = 1}^{N} \frac{\partial V}{\partial {a}_{i}} {da}_{i} \qquad ( 5 )$$

Various embodiments of the invention make use of AD sensitivities to provide estimates of the Greeks with which option traders are customarily relatively more familiar. For many types of financial contracts, it is challenging to relate such AD sensitivities to the formulae familiar to option traders as option Greeks. For example: a CMS spread option's inputs (and the corresponding AD sensitivities of the valuation risk functions) are typically swap rates, futures prices and cash deposit rates for curve building, and all of the cap and swaption quotes that make up a volatility cube. As other examples, a barrier option depends on several observations of its underlying, resulting in a collection of AD sensitivities and a quanto option depends on both the volatility of the underlying and that of the FX rate, giving multiple AD sensitivities.

In contrast to the stylized, textbook formulae like equation (3), AD sensitivities are typically numerous, but contain practical hedging and modeling information for any real option or financial contract based on options or other financial derivatives in terms of the actual hedging trades and/or parameters that one might consider using to manage risk. For example, AD sensitivities might include the size of a spot trade in the underlying equity that would be needed to eliminate the first order exposure to changes in the stock price, and how sensitive the various components (likely unhedgeable) of the forward curve model are to the valuation. In the case of the CMS option example, the full pattern of volatility exposure over the volatility cube would be available.

### Generic Delta

In this portion of the description, methods and systems for using AD sensitivities to develop a generic concept of delta are disclosed. This generic delta is then shown to reduce to well known option Greek formulae in special cases where option Greeks are algebraically determinable.

Delta is arguably the most fundamental of the Greeks and reflects the non-linear relationship between payoff and the value of an underlying that is fundamental to the concept of an option. Consider the arbitrary contract with value V(\vec{a}) depending on a collection of N input parameters [a₁, a₂, . . . a_{N}] represented by the vector \vec{a} and having the full set of AD sensitivities provided by:

$$dV = {\sum }_{i = 1}^{N} \frac{\partial V}{\partial {a}_{i}} {da}_{i} \qquad ( 5 )$$

As used herein, the value V of a contract or product should be understood to mean the expected at-expiry value of the contract or product, unless the context dictates otherwise. It will be appreciated that each of the terms of the right hand side of the equation (5) sum may be provided by known AD routines. We begin with a set of M scalar-valued functions of \vec{a}, {Fⱼ(\vec{a}); j=1 . . . M} which are (at this stage) arbitrary, but which we may use to represent the expected at-expiry values of the M underlyings of the financial contract V(\vec{a}). As used herein, the value of an underlying Fⱼ should be understood to mean the expected at-expiry value of the underlying, unless the context dictates otherwise. The total derivative of each such scalar-valued function weighted by an amount Δⱼ may be added and subtracted to the right hand side of equation (5):

$$dV = {\sum }_{i = 1}^{N} \frac{\partial V}{\partial {a}_{i}} {da}_{i} - {\sum }_{j = 1}^{M} {Δ}_{j} {dF}_{j} + {\sum }_{j = 1}^{M} {Δ}_{j} {dF}_{j} \qquad ( 6 )$$

The ji^{th} element of the Jacobian matrix J relating these functions to the input parameters \vec{a} is given by

$${J}_{ji} = \frac{\partial {F}_{j}}{\partial {a}_{i}} \qquad ( 7 )$$

We have:

$$d {F}_{j} ( \vec{a} ) = {\sum }_{i = 1}^{N} {J}_{j i} d {a}_{i} \qquad ( 8 )$$

Substituting equation (8) into equation (6) yields:

$$d V = {\sum }_{i = 1}^{N} ( \frac{\partial V}{\partial {a}_{i}} - {\sum }_{j = 1}^{M} {Δ}_{j} {J}_{j i} ) d {a}_{i} + {\sum }_{j = 1}^{M} {Δ}_{j} d {F}_{j} ≡ {\sum }_{i = 1}^{N} {v}_{i} d {a}_{i} + {\sum }_{j = 1}^{M} {Δ}_{j} d {F}_{j} \qquad ( 9 )$$

where νᵢ is defined as:

$${v}_{i} = \frac{\partial V}{\partial {a}_{i}} - {\sum }_{j = 1}^{M} {Δ}_{j} {J}_{j i} \qquad ( 10 )$$

If we can choose a set of values {Δⱼ}, j=1 . . . M that eliminates each of the νᵢ, we transform, or “reproject”, the sensitivities of V from the original variables {aᵢ}, i=1 . . . N to the new variables {ⱼ}, j=1 . . . M. This re-projection to the new variables is possible when M≥N. When M<N, there is residual sensitivity to \vec{a}.

It can be helpful for understanding this risk re-projection to interpret the derivation of equations (5)-(10) geometrically by using vector notation in the place of matrix notation. The infinitesimals {daᵢ}; i=1 . . . N in the equation (5) full set of AD sensitivities form a sensitivity vector space [symbol] . Using the notation {\vec{e}ᵢ}; i=1 . . . N to denote an orthonormal set of basis vectors spanning the space, the following vector may be defined:

$$d \vec{a} = {\sum }_{i = 1}^{N} d {a}_{i} {\vec{e}}_{i} \qquad ( 11 )$$

where daᵢ=\vec{e}ᵢ·d\vec{a}≡\vec{e}ᵢ^{T}d\vec{a}. Equation (5) can then be expressed as:

dV=\vec{∇}V·d\vec{a}≡\vec{∇}V^{T}d\vec{a} (12)

where equation (12) defines \vec{∇}V as a vector with N elements, whose i^{th} element is

$$\frac{\partial V}{\partial {a}_{i}}$$

—i.e.

$$\vec{∇} V = {[ \frac{\partial V}{\partial {a}_{1}} , \frac{\partial V}{\partial {a}_{2}} , … \frac{\partial V}{\partial {a}_{N}} ]}^{T} .$$

The total derivative (equations (5) and (12)) is therefore a projection of \vec{∇}V onto d\vec{a}. Equation (10) becomes:

\vec{ν}^{T}=\vec{∇}V^{T}−\vec{Δ}^{T}J (13)

where the j^{th} element of the M-element vector \vec{Δ} is Δⱼ and \vec{ν} is the N-element vector

$$\vec{v} = {\sum }_{i = 1}^{N} {v}_{i} {\vec{e}}_{i}$$

(14)
Taking the transpose of and rearranging equation (13) yields:

$$\vec{∇} V = {J}^{T} \vec{Δ} + \vec{v} = {\sum }_{j = 1}^{M} {Δ}_{j} \vec{∇} {F}_{j} + \vec{v} \qquad ( 15 )$$

where moving from equation (13) to (15) makes use of the fact that the j^{th} column of j^{T} is \vec{∇}Fⱼ. Considering equation (15) in more detail, it can be observed that the market risk of the financial contract V has been decomposed into two components (which may be referred to as reprojected sensitivity vectors): a first component J^{T}\vec{Δ}=Eⱼ₌₁^{M}Δⱼ\vec{∇}Fⱼ within the underlying sensitivity subspace [symbol] and spanned by the vectors {\vec{∇}Fⱼ} and a second component \vec{ν} in a residual space [symbol] . By choosing different coefficients {Δⱼ} which are still arbitrary, the contribution of the first (underlying sensitivity subspace [symbol] ) component to \vec{∇}V in equation (15) can be controlled. The maximal contribution of the first (underlying sensitivity subspace [symbol] ) component to \vec{∇}V in equation (15) is obtained when |\vec{ν}| is minimized, which is achieved when \vec{ν} is orthogonal to underlying sensitivity subspace [symbol] ; or when:

(J^{T}\vec{Δ})·ν=0. (16)

When M<N, equation (16) is equivalent to linear regression, which minimizes the sum of squares of the {νᵢ},

$${\sum }_{i = 1}^{N} {v}_{i}^{2} ≡ \vec{v} \cdot \vec{v} ≡ {\vert \vec{v} \vert}^{2} \qquad ( 17 )$$

giving \vec{Δ} as

\vec{Δ}=(JJ^{T})⁻¹J\vec{∇}V (18)

In the common case of M=1, equation (18) reduces to:

$$Δ = {Δ}_{1} = \frac{\vec{∇} {F}_{1} \cdot \vec{∇} V}{{\vert \vec{∇} {F}_{1} \vert}^{2}} \qquad ( 19 )$$

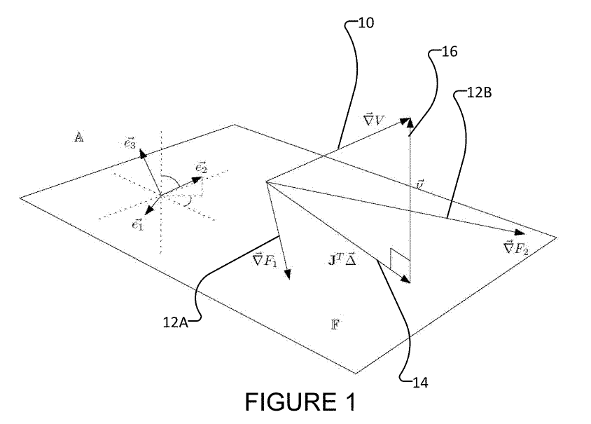

FIG. 1 illustrates this geometrical interpretation of equation (15) for the case where N=3 and M=2. FIG. 1 shows a first vector 10 corresponding to the left hand side of equation (15) (\vec{∇}V) and the sensitivity of the expected at-expiry value of the financial contract Vin the sensitivity vector space [symbol] . The FIG. 1 vectors 12A, 12B represent the basis vectors \vec{∇}F₁, \vec{∇}F₂ which span the underlying sensitivity vector subspace [symbol] and may be considered to be sensitivity vectors of the underlyings, where we may interpret {Fⱼ(\vec{a}); j=1 . . . M}, which are still arbitrary, to be the expected at-expiry values of the underlyings of the contract V(\vec{a}). Equation (15) is illustrative of a decomposition of sensitivity vector 10 into a pair of components: a first component vector 14 (J_{T}\vec{Δ}) within the underlying sensitivity subspace [symbol] spanned by the basis vectors 12A, 12B; and a second component vector 16 (\vec{ν}) in the residual space [symbol] None of the vectors 10, 12A, 12B, 14, 16 are necessarily aligned with the basis vectors {\vec{e}₁, \vec{e}₂, \vec{e}₃} for the sensitivity vector space [symbol] , which may be defined by the risk factors {daᵢ}; i=1 N in the complete set of AD sensitivities (equation (5)). It will be appreciated from FIG. 1, that the maximal contribution of the underlying sensitivity subspace [symbol] vector 14 to the sensitivity vector 10 occurs when residual vector 16 (\vec{ν}) is orthogonal to the underlying sensitivity subspace [symbol] .

We now apply this interpretation to the example contract of a European call option. Let V(\vec{F}(\vec{a}),\vec{a}) be the at-expiry value of a European call option whose payoff depends on one or more of N input parameters \vec{a} both directly and through a set of observations of M<N underlyings, whose expected values at each observation time (typically close to option expiry) are \vec{F}(\vec{a}). Equation (15) gives a decomposition of the risk vector \vec{∇}V of the option into two orthogonal components. Below it is shown that the first component (Σⱼ₌₁^{M}Δⱼ\vec{∇}Fⱼ) is a linear combination of the risk vectors of the option's underlyings, weighted by the M values {Δⱼ}, each of which is the delta to the corresponding underlying's at-expiry expected value. Further below, it will be shown that the second component may be interpreted as the vega (ν) of the option.

For the general case, where M>1, we can consider the concept of a conceptual “delta-weighted aggregate” underlying, which may be defined according to

$$F = {\sum }_{j = 1}^{M} {\hat{Δ}}_{j} {F}_{j} \qquad ( 20 A )$$

where \hat{Δ}ⱼ is a normalized version of the equation (15) coefficient defined according to

$${\hat{Δ}}_{j} = \frac{{Δ}_{j}}{{\sum }_{j = 1}^{M} {Δ}_{j}} \qquad ( 20 B )$$

We then may define a scalar delta Δ (also referred to herein as a maximal delta Δ, for reasons explained below) according to:

$$Δ = \frac{δV}{δF} \qquad ( 20 C )$$

which expresses the notional concept of the option Greek delta being the change in the contract value (V) with respect to its underlying (in this case, the equation (20A) delta-weighted aggregate underlying).

Changes in the financial contract's underlyings {Fⱼ} arise through changes in the values of the input values \vec{a}. If we denote a small change in the i^{th} element of \vec{a} by δaᵢ, then a given “market move” can be expressed as

$$\vec{δ} a = {\sum }_{i = 1}^{N} δ {a}_{i} {\vec{e}}_{i} \qquad ( 20 D )$$

Then, in accordance with equation (15), a change in the financial contract value (V) resulting from the small market move \vec{δ} a can be expressed as:

δV=\vec{∇}V·\vec{δ}a=(J^{T}\vec{Δ})·\vec{δ}a+\vec{ν}·\vec{δ}a≡δV_{Δ}+δV_{ν} (20E)

where we have used equation (15) and we have defined SV_{Δ} to be the contribution arising from the component of \vec{δ}a in the subspace [symbol] and δV_{ν} denotes the remainder. Any component of \vec{δ}a orthogonal to [symbol] makes no contribution to δV through changes in any of the underlyings. The impact of changes in the option's underlyings is contained entirely within

$$\begin{matrix}δ {V}_{Δ} = ( {J}^{T} \vec{Δ} ) \cdot \vec{δ} a & \\ = ( {\sum }_{j = 1}^{M} {Δ}_{j} \vec{∇} {F}_{j} ) \cdot ( {\sum }_{l = 1}^{N} δ {a}_{l} {\vec{e}}_{l} ) & \\ = ( {\sum }_{j = 1}^{M} {Δ}_{j} {\sum }_{i = 1}^{N} \frac{\partial {F}_{j}}{\partial {a}_{i}} {\vec{e}}_{i} ) \cdot ( {\sum }_{l = 1}^{N} δ {a}_{l} {\vec{e}}_{l} ) & \\ = {\sum }_{j = 1}^{M} {Δ}_{j} {\sum }_{i = 1}^{N} \frac{\partial {F}_{j}}{\partial {a}_{i}} {\sum }_{l = 1}^{N} δ {a}_{l} {\vec{e}}_{i} \cdot {\vec{e}}_{l} & \\ = {\sum }_{j = 1}^{M} {Δ}_{j} {\sum }_{i = 1}^{N} \frac{\partial {F}_{j}}{\partial {a}_{i}} δ {a}_{i} & ( 20 F ) \\ = {\sum }_{j = 1}^{M} {Δ}_{j} δ {F}_{j} & ( 20 G )\end{matrix}$$

where in equation (20F) we made use of the orthonormality of {eᵢ} basis and equation (20G) defines

$$δ {F}_{j} = {\sum }_{i = 1}^{N} \frac{\partial {F}_{j}}{\partial {a}_{i}} δ {a}_{i} \qquad ( 21 )$$

the impact of \vec{δ}a on the j^{th} option underlying g Fⱼ. Equation (21) illustrates that each Δⱼ is the linear response of option value to a small change in the j^{th} underlying Fⱼ induced by an arbitrary market move and may therefore be understood the be a delta.

In the case where M=1, the option has a single delta Δ₁ given by equation (19). When there are multiple underlyings (M>1), we may still wish to summarize the {Δⱼ} as a single number Δ, measuring the linear response of V to a change in “underlying” for some notion of effective single underlying, given a market move in a suitable direction. As equation (20E) shows, an arbitrary market move affects option value via both delta and vega. To isolate the contribution through delta, the directions that lie within the subspace [symbol] may be considered. One such direction is special, corresponding to the maximum possible effect the market can have on the option through its delta. That direction is the one which aligns with the component of the option's risk vector \vec{∇}V in [symbol] . This direction is given by the unit vector

$${\vec{e}}_{Δ} = \frac{{J}^{T} \vec{Δ}}{\vert {J}^{T} \vec{Δ} \vert} ≡ \frac{{\sum }_{j = 1}^{M} {Δ}_{j} \vec{Δ} {F}_{j}}{\vert {\sum }_{j = 1}^{m} {Δ}_{j} \vec{Δ} {F}_{j} \vert} \qquad ( 22 )$$

For a move with magnitude δs in this direction, the linear response of option value is

δV=\vec{∇}V·\vec{δ}a=\vec{∇}V·δa\vec{e}_{Δ}=δa|J^{T}\vec{Δ}| (23)

One approach to defining an effective single underlying F of an option with multiple underlyings {Fⱼ} is to form a weighted sum of the underlyings,

$$F = {\sum }_{j = 1}^{M} {w}_{j} {F}_{j} \qquad ( 24 )$$

The linear response of F to a magnitude act market move in the \vec{e}_{Δ} direction is

$$δ F = {\sum }_{j = 1}^{M} {w}_{j} {\vec{e}}_{Δ} \cdot \vec{∇} {F}_{j} \qquad ( 25 )$$

and a scalar delta may now be determined according to

$$Δ = \frac{δ V}{δ F} \qquad ( 26 )$$

The weight assigned to the contribution from the j^{th} underlying may be set to correspond to the Δⱼ, normalized by a factor Λ. Using equation (22), the change in F becomes

$$δ F = \frac{δ a}{Λ} \frac{( {J}^{T} \vec{Δ} ) \cdot ( {\sum }_{j = 1}^{M} {Δ}_{j} \vec{Δ} {F}_{j} )}{\vert {J}^{T} \vec{Δ} \vert} = \frac{δ a}{Λ} \vert {J}^{T} \vec{Δ} \vert \qquad ( 27 )$$

which in turn yields

Δ=Λ (28)

when substituted into equation (26) along with equation (23).

This definition of a scalar delta, summarizing the full set of {Δⱼ} for M underlyings, is therefore equivalent to the normalization scheme used in a delta-weighted definition of the effective scalar underlying Fin equation (26), under a market move in the delta direction. If we choose to normalize using the L₁ norm, then scalar delta may be determined via an absolute sum,

$$Δ = {\sum }_{j = 1}^{M} \vert {Δ}_{j} \vert \qquad ( 29 )$$

An alternative method for summarizing multiple deltas into a single value can be generated by considering the linear response of each underlying Fⱼ, to a market move in the delta direction,

ΔFⱼ=δa\vec{e}_{Δ}·\vec{∇}Fⱼ (30)

Using equation (22), the vector \vec{δ}F in [symbol] whose M components are δFⱼ may be expressed as

$$\vec{δ} F = \frac{δ a}{\vert {J}^{T} \vec{Δ} \vert} {JJ}^{T} \vec{Δ} \qquad ( 31 )$$

To summarize equation (31) as a scalar, its magnitude may be obtained according to

$$δ F = \sqrt{\vec{δ} F \cdot \vec{δ} F} = \frac{δ a}{\vert {J}^{T} \vec{Δ} \vert} \sqrt{{\vec{Δ}}^{T} {JJ}^{T} \vec{Δ}} \qquad ( 32 )$$

A scalar Δ may then be defined according to

$$Δ = \frac{δ V}{δ F} \qquad ( 33 )$$

for a move in the maximal delta direction \vec{e}_{Δ}. Using equations (32) and (33) and the fact that

$$\vert {J}^{T} \vec{Δ} \vert = \sqrt{{\vec{Δ}}^{T} {JJ}^{T} \vec{Δ}} ,$$

it may be shown that

$$Δ = \frac{{\vec{Δ}}^{T} {JJ}^{T} \vec{Δ}}{\sqrt{{\vec{Δ}}^{T} {JJ}^{T} {JJ}^{T} \vec{Δ}}} \qquad ( 34 )$$

The Δ of equation (34) may be referred to herein as maximal delta, because δV_{Δ} is maximized when δa is parallel to the maximal delta direction \vec{e}_{Δ}. There is no other market move that has a larger impact on option value through its underlyings.

Both forms of scalar delta for a multi-underlying option, equations (29) and (34), are just definitions there is no a priori reason to prefer one over the other, because they are both extrapolations of the concept of delta-hedging beyond the familiar setting in which it applies. Equation (29) is more readily interpretable in terms of delta-hedging, whereas equation (34) is more parsimonious. Both definitions however are maximal, in the sense that δV_{Δ} is maximized when \vec{δ}a is parallel to \vec{e}_{Δ}. There is no other market move that has a larger impact on option value through its underlyings.

At this stage, it may be noted that common choices for \vec{δ} a are often different. For interest rate options, a parallel shift may be applied to curve building instruments, so that δaᵢ=δa for i=1 . . . N. This selection of δaᵢ is not, in general, the same as Δa\vec{e}_{Δ}. Consequently, this type of parallel curve shift can change both the underlying and its volatility, although the effect on the latter is typically far smaller than on the former.

### Gamma

Risk reprojection, as described above, can be generalized to higher order Greeks in a straightforward manner. The change in value of an arbitrary financial contract can be expressed as:

$$\begin{matrix}δ V ( \vec{a} ) = {\sum }_{i = 1}^{N} \frac{\partial V}{\partial {a}_{i}} δ {a}_{i} & ( 35 ) \\ = \frac{1}{2} {\sum }_{i , l = 1}^{N} \frac{{\partial }^{2} V}{\partial {a}_{i} \partial {a}_{l}} {δa}_{i} {δa}_{l} & \\ = {\sum }_{i = 1}^{N} ( \frac{\partial V}{\partial {a}_{i}} - {\sum }_{j = 1}^{M} {J}_{ji} {Δ}_{j} ) {δa}_{i} + & \\ \frac{1}{2} {\sum }_{i , l}^{N} ( \frac{{\partial }^{2} V}{\partial {a}_{i} \partial {a}_{l}} - {\sum }_{j , k = 1}^{M} {Γ}_{jk} {J}_{ji} {J}_{kl} ) {δa}_{i} {δa}_{l} + & \\ {\sum }_{j = 1}^{M} {Δ}_{j} δ {F}_{j} + \frac{1}{2} {\sum }_{j , k = 1}^{M} {Γ}_{jk} δ {F}_{j} δ {F}_{k} + O ( δ {F}^{3} ) & ( 36 )\end{matrix}$$

where, in addition to the weights {Δⱼ} from equations (8)-(10) above, we have introduced an M×M matrix of weights Γⱼₖ. By minimizing the contribution of the first two terms of equation (36) to δV(\vec{a}) over both the {Δⱼ} and {Γⱼₖ}, we calculate both delta and gamma in terms of the first and second order derivatives of V(\vec{a}) with respect to \vec{a}.

However, this method for ascertaining delta and gamma necessitates obtaining both the first and second order derivatives of V(\vec{a}) with respect to \vec{a}. While currently available AD implementations provide complete first order derivatives, second order derivatives are impractical to provide comprehensively (because the complexity tends to scale as N²). For this reason, although the re-projection approach is possible, currently preferred embodiments for determining higher order sensitivities use a finite difference approach applied to the first order derivatives obtained by AD. The efficiency of AD means that the cost of bumping \vec{∇}V(d) is usually of the same order as bumping V(\vec{a}). The method of finite differences can be applied at any stage of the process. For example, given a bump defined by the small vector \vec{δ}a in equation (20D) and a forward difference of the AD sensitivities \vec{∇}V(\vec{a}) is given by:

$$\frac{\vec{∇} V ( \vec{a} + \vec{δ} a ) - \vec{∇} V ( \vec{a} )}{\vert \vec{δ} a \vert} \qquad ( 37 )$$

Backward and centered differences may be similarly defined. If the bump is aligned with the i^{th} input, \vec{δ}a=a\vec{e}ᵢ, we obtain an approximation of one column of the Hessian matrix

$${H}_{il} = \frac{{\partial }^{2} V}{\partial {a}_{i} \partial {a}_{l}} ;$$

l=1 . . . N. Additionally or alternatively, the same bump may be applied to equation (18) for each element of the vector \vec{Δ}. The j^{th} element of the corresponding gamma vector under forward difference may then be given by

$${Γ}_{j} \approx \frac{1}{δ a} ( {Δ}_{j} ( \vec{a} + δ a {\vec{e}}_{Δ} ) - {Δ}_{j} ( \vec{a} ) ) \qquad ( 38 )$$

The same exercise may be performed for equation (34) to construct a maximal gamma

$$Γ \approx {\sum }_{j = 1}^{M} {Γ}_{j} \qquad ( 39 )$$

The equation (39) gamma is maximal in the sense that it is obtained by bumping maximal delta from equation (34) in the maximal delta direction \vec{e}_{Δ}, given, for example, by equation (22).

In some embodiments, other techniques may be used to obtain an approximation of maximal gamma where the finite difference bump may be applied in the maximal delta direction \vec{e}_{Δ} —i.e. \vec{δ}a=δa\vec{e}_{Δ}. A gamma vector \vec{Γ} to be a set of {Γⱼ}_{j=1 . . . M} where each Γⱼ is defined according to:

$${Γ}_{j} \approx \frac{1}{δ a} ( {Δ}_{j} ( \vec{a} + δ a {\vec{e}}_{Δ} ) - {Δ}_{j} ( \vec{a} ) ) \qquad ( 39 A )$$

where Δⱼ is defined in accordance with equation (15) under the conditions of equation (16) and/or (17) and where equation (39A) explicitly includes the dependence of Δⱼ on the market vector \vec{a} and the displaced market vector \vec{a}+δa\vec{e}_{Δ}. The maximal delta Δ may then be determined in accordance with any of the techniques described above (e.g. equation (19) or equation (34) for both the market vector \vec{a} and the displaced market vector \vec{a}+δa\vec{e_{Δ}} to yield an expression for maximal Γ which is:

$$Γ \approx \frac{1}{δ a} ( Δ ( \vec{a} + δ a {\vec{e}}_{Δ} ) - Δ ( \vec{a} ) ) \qquad ( 39 B )$$

where the Δ as used in equation (39B) is the maximal delta Δ and where, once again, equation (39B) explicitly includes the dependence of Δⱼ on the market vector \vec{a} and the displaced market vector \vec{a}+δa\vec{e}_{Δ}.

### Generic Vega

For a European option in the Black model, again working with at-expiry quantities as described in connection with equation (3), vega is defined to be

$${{v}_{B} ≡ \frac{\partial }{\partial σ} \vert}_{{F}_{T}} ( {F}_{T} Φ ( {d}_{1} ) - K Φ ( {d}_{2} ) ) = {F}_{T} φ ( {d}_{1} ) \sqrt{T} \qquad ( 40 )$$

where ϕ(x) denotes the standard normal density. As is known, vega is a metric representative of the effect on the option price V of the scale parameter in the distribution of F_{T}. For an arbitrary distribution, however, particularly one generated by a stochastic volatility model, it is not always possible to identify such a parameter, and even if such a parameter could be identified, looking at its effect on the option price in isolation has limited use. For example in the Heston model, the variance ηₜ follows a Cox-Ingersoll-Ross (CIR) process with mean reversion κ, long-run variance θ and volatility of volatility ξ

dFₜ=\sqrt{ηₜ}FₜdWₜ

dηₜ=κ(θ−ηₜ)dt+ξ\sqrt{ηₜ}dZₜ (41)

where dWₜdZₜ=ρdt. The width of the distribution for Fₜ is a function of the parameters κ, θ and ξ. The volatility of volatility, ξ, is perhaps the closest parameter to a scale parameter, but if we were to define vega as the first order effect of ξ, it would still be of very limited use. Of primary practical use is the effect of quoted volatility on the option being modelled, which influences all three parameters κ, θ and ξ through their calibration to market data. However, such an effect moves away from the realm of clean, theoretical formulae like the equation (40) formula for vega which guide the intuition of traders. Instead, such an effect moves into the realm of AD sensitivities, but we attempt to bridge the gap between these two.

The classical vega formula of equation (40) arises in the very model commonly used for quoting volatility in the first place, where there are only two parameters, F_{T} and σ. If V_{B}(F_{T},σ) is the at-expiry value of an option in such a model,

$${{{dV}_{B} ( {F}_{T} , σ ) = \frac{\partial {V}_{B}}{\partial σ} \vert}_{σ} {dF}_{T} + \frac{\partial {V}_{B}}{\partial σ} \vert}_{{F}_{T}} d σ ≡ {Δ}_{B} {dF}_{T} + {v}_{B} d σ \qquad ( 42 )$$

For arbitrary models, this formulation must be generalized. One way to view vega generally is as a means of capturing the effect of nonlinearity in the option's payoff. For an arbitrary payoff function f(x) of some underlying observable x, the at-expiry value of the corresponding option, V, can be expressed as an expectation over the risk-neutral distribution of x,

V= [symbol] [ƒ(x)] (43)

If f(x) is linear, then it and the expectation operator [symbol] [ ] commute,

[E,ƒ](x)≡ [symbol] [ƒ(x)]−ƒ( [symbol] [x])=V−ƒ(F_{T})=0 (44)

but non-linearity in f is generally required by the definition of an option (otherwise the option reduces to a forward). By Jensen's inequality, for an option, the commutator [[ [symbol] ,ƒ](x) is non-zero. f(F_{T}) is the intrinsic value of the option and the commutator is its time value in the known decomposition,

V=ƒ(F_{T})+[ [symbol] ,ƒ](x) (45)

For a call option in the Black model, this takes the form:

$${V}_{B} ( {F}_{T} , σ ) = max ( {F}_{T} - K , 0 ) + \frac{σ {F}_{T}}{2} {\int }_{0}^{T} \frac{φ ( {d}_{1} )}{\sqrt{t}} dt \qquad ( 46 )$$

The first term in either of equations (45) and (46) makes no contribution to vega (only to delta). The first term depends only on the first moment of the distribution [symbol] [x]=F_{T}. The scale parameter can be identified with the second central moment (whether arithmetic or geometric) of the distribution, which is the only contribution to vega in the Black model. In arbitrary models, however, any higher moment may make a contribution to the time value and may be included, in some embodiments, in a measure of vega.

Intuitively, in equation (42), vega is effectively expressed as the remainder of the total derivative of the option after removing the effect of the forward value of the underlying (the delta).

$${vega \sim {dV}_{B} ( {F}_{T} , σ ) - \frac{\partial {V}_{B}}{\partial {F}_{T}} \vert}_{σ} {dF}_{T} \qquad ( 47 )$$

This may be accomplished by varying the complete set of parameters on which the option value depends in such a way that F_{T} is held constant. In the notation used above for the geometric reprojection, this may be accomplished by obtaining the component of the total derivative, \vec{∇}V, perpendicular to every vector \vec{Δ}Fⱼ. This vector \vec{ν} has already been identified in equation (13) and in FIG. 1:

$$\vec{v} = \vec{∇} V - {J}^{T} \vec{Δ} ≡ \vec{∇} V - {\sum }_{j = 1}^{M} {Δ}_{j} \vec{∇} {F}_{j} \qquad ( 48 )$$

as the residual after projecting \vec{∇}V onto the underlying sensitivity subspace [symbol] . The single number that best represents this residual risk vector is of course its length |\vec{ν}|. In some embodiments, this length |\vec{ν}| is the definition of vega.

There is no direct analog of the values {Δⱼ}; j=1 . . . M for vega, because there is no direct analog of the option's underlyings {Fⱼ}; j=1 . . . M. Instead, we have a collection of N components of \vec{ν} on the {\vec{e}ᵢ} basis, νᵢ=\vec{ν} ·\vec{e}ᵢ. Returning to equation (20E), the following expression may be obtained:

$$δ V = \vec{∇} V \cdot \vec{δ} a ≡ δ {V}_{Δ} + δ {V}_{v} = {\sum }_{j = 1}^{M} {Δ}_{j} δ {F}_{j} + {\sum }_{i = 1}^{N} {v}_{i} δ {a}_{i} \qquad ( 49 )$$

for an arbitrary change in market data \vec{δ}a=Σᵢ₌ᵢ^{N}δaᵢ\vec{e}ₜ, where equation (20G) has been used for the delta term.

In the description above, delta and vega have been emphasized as the fundamental Greeks of interest in this description and the application of finite difference analysis to the AD-generated sensitivities has been suggested as a technique for approximating gamma. Other quantities which may be understood to be Greeks may be ascertained in some embodiments.

### Discounting and Rho

Discounting risk for options is commonly given the name “rho” and defined as the first order effect of changes in the risk-free rate r on the present value of an option. For a European call option in the Black-Scholes model, the theoretical rho is obtained by differentiating the present value with respect to the risk free rate r,

ρ_{BS}=KTe^{-rT}Φ(d₂) (50)

The discussion above suggested working in at-expiry terms to encapsulate the details of modeling the forward value of the option's underlying. Specifically, the at-expiry value of the option, V, and the forward value of each underlying, Fⱼ, were used, thereby eliminating any discounting risk from the analysis and allowing a focus on Δj and \vec{ν} as in equation (15). To examine the role of discounting risk on this analysis, the analysis may be reworked in spot, not forward, terms. Rather than defining delta via reprojection of the risk vectors of forward value V onto forward underlying values {Fⱼ}, a spot delta may be defined via reprojection of the risk vectors of present option value W, where

W=PₜV (51)

onto the present value of the underlyings

{Gⱼ=PⱼFⱼ} (52)

where Pₜ is the discount factor from option settlement date t to the valuation date and Pⱼ is the discount factor from the natural payment time of the j^{th} underlying, to the valuation date.

It may be observed that the spot price of the underlying is not used, because such use of the spot price of the underlying would undo all the good work done by encapsulating funding, dividend and any other modeling details in the forwards {Fⱼ}. By working with discounted forwards, the sensitivity to discounting may be isolated from sensitivity to any other detail of modeling the expected future value of underlyings. In some implementations, such details could additionally or alternatively be subsequently analyzed.

By reworking the reprojection analysis in present-value terms, the spot delta may be related to forward delta and a generic expression may be determined for discounting risk (rho). In terms of spot delta and present-value quantities, equation (6) becomes:

$$dW = {\sum }_{i = 1}^{N} ( \frac{\partial W}{\partial {a}_{i}} - {\sum }_{j = 1}^{M} {Δ}_{j}^{S} \frac{\partial {G}_{j}}{\partial {a}_{i}} ) {da}_{i} + {\sum }_{j = 1}^{M} {Δ}_{j}^{S} {dG}_{j} \qquad ( 53 )$$

where the expression Δⱼ^{S} refers to the j^{th} spot delta. Applying the chain rule to equations (51) and (52), substituting into equation (53) and grouping like terms then yields

$${P}_{t} dV + {VdP}_{t} = {\sum }_{i = 1}^{N} ( {P}_{t} \frac{\partial V}{\partial {a}_{i}} - {\sum }_{j = 1}^{M} {Δ}_{j}^{S} {P}_{j} \frac{\partial {F}_{j}}{\partial {a}_{i}} ) {da}_{i} + {\sum }_{i = 1}^{N} ( V \frac{\partial {P}_{t}}{\partial {a}_{i}} - {\sum }_{j = 1}^{M} {Δ}_{j}^{S} {F}_{j} \frac{\partial {P}_{j}}{\partial {a}_{i}} ) {da}_{i} + {\sum }_{j = 1}^{M} {Δ}_{j}^{S} ( {F}_{j} {dP}_{j} + {P}_{j} {dF}_{j} ) \qquad ( 54 )$$

### Using

$${\sum }_{i = 1}^{N} \frac{\partial {P}_{k}}{\partial {a}_{i}} {da}_{i} = {dP}_{k}$$

for k=j, t equation (54) may be simplified to

$$dV = {\sum }_{i = 1}^{N} ( \frac{\partial V}{\partial {a}_{i}} - {\sum }_{j = 1}^{M} \frac{{Δ}_{j}^{S}}{{P}_{jt}} \frac{\partial {F}_{j}}{\partial {a}_{i}} ) {da}_{i} + {\sum }_{j = 1}^{M} \frac{{Δ}_{j}^{S}}{{P}_{jt}} {dF}_{j} \qquad ( 55 )$$

where the discount factor from time t to time tⱼ is given by

$${P}_{jt} = \frac{{P}_{t}}{{P}_{j}} \qquad ( 56 )$$

Comparing with Eq. (18), it may be observed that the component of dV in the subspace [symbol] is maximized when the coefficients of {dFⱼ} obey

Δⱼ^{S}=PⱼₜΔⱼ (57)

for j=1 . . . M. Each spot delta Δⱼ^{S} is the appropriately discounted forward delta, as would be intuitively expected. For options whose underlyings are observed at expiry, spot and forward delta coincide—i.e. Pⱼₜ=1 and Δⱼ^{S}=Δⱼ, for each of the M underlyings. This result is perhaps no surprise given that delta is, loosely, just a ratio of change in option value to change in underlyings, and if discounting affects both numerator and denominator in the same manner then its contribution cancels. Spot delta only differs from delta in so-called “path-dependent” options, such as in American options, whose payoffs are functions of underlying observations made at times differing from the option expiry time.

Having related spot delta Δⱼ^{S} and forward delta Δⱼ, the same exercise may be performed for vega. In doing so, a definition of discounting risk under the reprojection methodology may be obtained. In the vector notation of equations (11)-(19), by definition of {Δⱼ^{S}},

$$\vec{∇} W = {\sum }_{j = 1}^{M} {Δ}_{j}^{S} \vec{∇} {G}_{j} + \vec{ɛ} \qquad ( 58 )$$

where the residual vector \vec{ε} is orthogonal to the space [symbol] spanned by the M vectors {\vec{∇}Gⱼ}

$$( {\sum }_{j = 1}^{M} {Δ}_{j}^{S} \vec{∇} {G}_{j} ) \cdot \vec{ɛ} = 0 \qquad ( 59 )$$

when the {Δⱼ^{S}} are the components of the vector

$${\vec{Δ}}^{S} = {\sum }_{j = 1}^{M} {Δ}_{j}^{S} \vec{∇} {G}_{j} = {( {KK}^{T} )}^{- 1} K \vec{∇} W \qquad ( 60 )$$

solving the problem posed in equation (58) is analogous to solving the problem posed in equation (15) and discussed above, except that instead of equation (7), the ji^{th} element of the present value Jacobian K is given by

$${K}_{ji} = \frac{\partial {G}_{j}}{\partial {a}_{i}} \qquad ( 61 )$$

Expanding W and Gⱼ in equation (58) using the chain rule yields

$$\vec{∇} V = {\sum }_{j = 1}^{M} \frac{{Δ}_{j}^{S}}{{P}_{jt}} \vec{∇} {F}_{j} + \frac{1}{{P}_{t}} ( \vec{ɛ} - \vec{ρ} ) \qquad ( 62 )$$

where the discounting risk vector \vec{ρ} is given by

$$\vec{ρ} = V \vec{∇} {P}_{t} - {\sum }_{j = 1}^{M} {F}_{j} {Δ}_{j}^{S} \vec{∇} {P}_{j} \qquad ( 63 )$$

Converting from spot delta to forward delta with equation (57) and comparing with equation (15) allows identification of the two components of the residual vector \vec{ε},

\vec{ε}=\vec{ρ}+Pₜ\vec{ν} (64)

In other words, the residual (after removing spot delta from the sensitivities of an option's present value) is composed of discounting risk (\vec{ρ}) and “spot” vega Pₜ\vec{ν}, where the spot vega is related to forward vega \vec{ν} by discounting from expiry.

In the Black Scholes model, where M=1 and Pⱼ=Pₜ=e^{-rt}, so dPₜ=−Pₜ(tdr+rdt). The discount rate component (i.e. coefficient of dr) of the vector \vec{ρ} in equation (63) for a call option expiring at time T may therefore be expressed as

ρ_{BS}=−TP_{T}(F_{T}Φ(d₁)−KΦ(d₂)−F_{T}Δ_{BS}) (65)

which, given equation (1) recovers equation (50). In contrast, equation (63) permits determination of the discounting risk of an option of arbitrary type expiring at time t, and in an arbitrary model, as long as AD sensitivities are available.

### Physical Options

Working in at-expiry terms and solving equation (15) has the advantage of efficiency for calculating delta and vega for options whose underlying observations are co-terminal with the payoff because the calculation is simplified by the absence of discounting risk. However, working in present-value terms and solving equation (58) allows determination of rho in addition to delta and vega. Consequently, the equation (58) solution affords a more intuitive definition of delta for path-dependent options, at the cost of the extra work of subtracting \vec{ν} from \vec{∇}W to isolate (discounted) vega.

Implicit in the analysis thus far has been the assumption of cash-settlement—i.e. an option expiry tat which time a payment is made to the option's owner, and the present value of that payment, as per Eq. (51), is the option's value. This assumption does not mean that the technique cannot be applied to physical options, but the technique may be more complicated for physical options. For physically settled options, a single time t may be identified to use in the discounting analysis, together with the relevant collection of observations that constitutes the underlyings.

This identification of a single time t is often done as part of a pricing model anyway. For example, a physically settled European swaption struck at k is economically equivalent to a payment of max(sₜ−k; 0) at its expiry t where sₜ is the value of the swap rate, even though the contract references the swap itself, not sₜ, as an observable property of that swap. As another example, while an American option may be exercised at any time until its maturity tₘ, some quasi closed form pricing models value such an option relative to the equivalent European option expiring at t=tₘ by approximating the extra value held in the right to exercise early. In doing so, such models effectively express the physical American option as a cash-settled equivalent with expiry t.

It may be challenging to determine algorithmically the cash-settled equivalent of an arbitrary financial derivative contract allowing for any collection of (perhaps nested) choice rights afforded to the holder. However, for any payment obligation (whether or not convexity is present) and for any physical option for which a cash-settled equivalent is available, option greeks may be ascertained using the reprojection approach described herein. More specifically, equation (58) can be applied to portfolio of such derivatives as a means of detecting optionality (or any other form of convexity) as long as both the AD sensitivities, at each observation time, are available for the portfolio and for those of each observable referenced in the payoffs of the derivatives. Then, after removing the contribution of delta and rho using equations (60) and (63), only vega remains. If |\vec{ν} |=0, then there is no optionality—i.e. the financial instrument in question is a statically hedgeable delta-one portfolio which can be verified explicitly through the delta calculation as a consistency check. If on the other hand there is non-zero vega (|\vec{ν} |≠0), then there is optionality present which requires dynamic hedging to replicate.

### Time Decay and Theta

The value of an option changes with time even if all other factors are held constant, and the name given to this time decay is “theta”. For a European call option in the theoretical Black-Scholes model,

$$Θ = - \frac{{S}_{0} φ ( {d}_{1} ) σ}{2 T} - {rKe}^{- rT} Φ ( {d}_{2} ) \qquad ( 66 )$$

As with rho, the time decay (theta) of real options differs significantly from the stylized (theoretical) form of equation (48). For example, the passage of time influences the option not only directly but through forward value F_{T}, but forward contracts specify a payment date, not a payment time, and so we are limited to a resolution of business days when measuring the contribution of the forward. However, many conventions for converting from dates to times include weekends and other non-business days, giving rise to jumps in theta. One approach to mitigate such jumps in theta estimates could be to apply finite difference techniques using relatively large (coarse grain) finite differences in time for theta and then scaling to give a daily measure. However, theta changes the most when an option is very close (e.g. days or hours) to expiry, where it would be undesirable to use such a coarse-graining. In some embodiments, an approach similar to that described above for rho could be used to derive an equivalent theta in a suitable model. For example, given an at-expiry option price V and an at-expiry expected value of the underlying Fin an arbitrary model, a volatility may be implied from the Black model as long as F is positive. Equation (66) may then be evaluated. For negative values of F, an appropriate model may be chosen that admits such negative values, but the same approach may still be used.

### Applications

This section of the description describes the application of the concepts discussed above to a number of practical examples.

### The Black Scholes Model

First, it is demonstrated how the generic formulae for delta and vega discussed above reduce to the well understood theoretical equations (equations (3) and (40)) in the Black model. We start with deriving equation (3) from equation (1). For the equation (1) Black-Scholes model, the vector \vec{a} of input parameters is given by \vec{a}^{T}={S₀,r,σ}, so N=3. In terms of these inputs, the at-expiry value of the European call option is:

V(\vec{a})=αS₀Φ(d₁)−KΦ(d₂) (67)

where α=e^{rT}, Φ(⋅) denotes the cumulative standard normal distribution and

$${d}_{1 , 2} = \frac{1}{σ \sqrt{T}} [ ln ( \frac{{S}_{0}}{K} ) \pm ( r + \frac{{σ}^{2}}{2} ) T ] \qquad ( 68 )$$

The gradient vector \vec{∇}V is therefore given by:

$$\vec{∇} V = {( \frac{\partial V}{\partial {S}_{0}} , \frac{\partial V}{\partial r} , \frac{\partial V}{\partial σ} )}^{T} = {α ( Φ ( {d}_{1} ) , {tS}_{0} Φ ( {d}_{1} ) , \sqrt{t} {S}_{0} φ ( {d}_{1} ) )}^{T} \qquad ( 69 )$$

where ϕ(⋅) denotes the standard normal density function. There is a single underlying F_{T}=S₀α, so M=1 and

$$\vec{∇} {F}_{T} = {( \frac{\partial {F}_{T}}{\partial {S}_{0}} , \frac{\partial {F}_{T}}{\partial r} , \frac{\partial {F}_{T}}{\partial σ} )}^{T} = {α ( 1 , {tS}_{0} , 0 )}^{T} \qquad ( 70 )$$

Given the single underlying, there is a single weight Δⱼ|=Δ₁ and the residual vector \vec{ν} in equation (13) takes the form:

\vec{ν}=\vec{∇}V−Δ₁\vec{∇}F_{T}=α(Φ(d₁)−Δ₁,tS₀Φ(d₁)−Δ₁tS₀,\sqrt{t}S₀ϕ(d₁))^{T} (71)

with a “square length” given by:

\vec{ν}·\vec{ν}=α²((Φ(d₁)−Δ₁)²+(tS₀Φ(d₁)−Δ₁tS₀)²+(\sqrt{t}S₀ϕ(d₁))²) (72)

Equation (72) is minimized when

Δ₁=Φ(d₁)=Δ_{B} (73)

which is the same result as expected in the theoretical model of equation (3). The resulting residual (vega) vector is:

\vec{ν}=(0,0,\sqrt{t}F_{T}ϕ(d₁)) (74)

which yields a scalar vega value of ν_{B}=|\vec{ν}|=\sqrt{t}F_{T}ϕ(d₁), expressing the same result as expected from the theoretical model of equation (40).

Alternatively, delta Δ may be calculated from the generalized delta derived above using equation (19) to show

$$Δ = \frac{\vec{∇} V \cdot \vec{∇} {F}_{T}}{{\vert \vec{∇} {F}_{T} \vert}^{2}} = \frac{{α}^{2} ( Φ ( {d}_{1} ) + {t}^{2} {S}_{0}^{2} Φ ( {d}_{1} ) )}{{α}^{2} ( 1 + {t}^{2} {S}_{0}^{2} )} = Φ ( {d}_{1} ) = {Δ}_{B} \qquad ( 75 )$$

which again agrees with the theoretical result of equation (3).

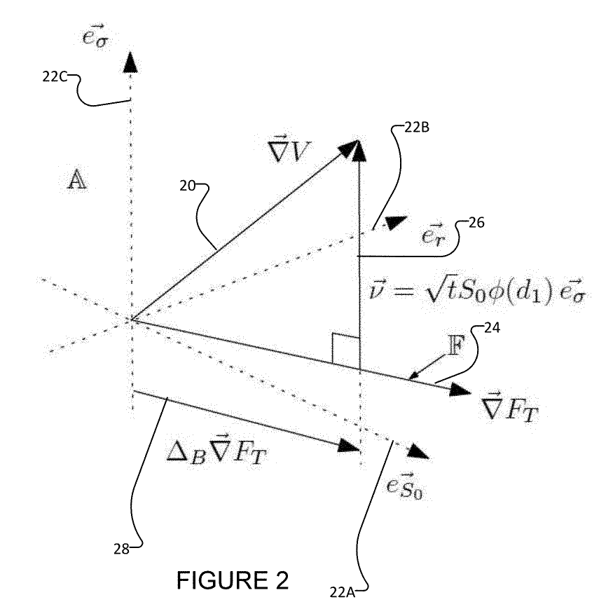

FIG. 2 shows the geometry of the application of the generalized delta and vega results described above to a European call option modelled according to the Black-Scholes model. FIG. 2 is analogous to FIG. 1, except that the various parameters of the general case (FIG. 1) are applied specifically to the Black-Scholes model of the European option in FIG. 2. The dimensionality of the FIG. 2 sensitivity space [symbol] is N=3 with the unit vectors 22A, 22B, 22C (\vec{e}₁,\vec{e}₂,\vec{e}₃) of \vec{e}_{S}_{₀},\vec{e}ᵣ,\vec{e}_{σ}. The dimensionality of the underlying sensitivity subspace [symbol] is M=1 and consequently, there is only one underlying sensitivity vector 24 (\vec{∇}F₁=\vec{∇}F_{T}) that spans the underlying sensitivity subspace [symbol] . Further, the forward price F_{T} has no sensitivity to the volatility σ and, therefore, \vec{∇}F_{T} lies entirely within the S₀-r plane which makes the residual vector \vec{ν} (vector 26 of FIG. 2) parallel to \vec{e}_{σ}. FIG. 2 also shows, as vector 28, the interpretation of the Black delta (Δ_{B}) which is a scaling factor relating changes in the underlying sensitivity vector (\vec{∇}F_{T}) to the component of the option value sensitivity vector 20 (\vec{∇}V) in the underlying sensitivity subspace [symbol] . FIG. 2 also shows the interpretation of the Black vega ν=|\vec{ν}|, which is the magnitude of the residual vector 26 (\vec{ν}) and which corresponds to the magnitude of the component of the vector 20 (\vec{∇}V) that is orthogonal to the underlying sensitivity subspace [symbol] .

### Quanto Options

The Black-Scholes European option example described above is somewhat simple because vega was already orthogonal to delta; that is, \vec{∇}F_{T} lay entirely within the S₀-r plane. For this reason, despite having a sensitivity space [symbol] with N=3, so the Black-Scholes European option is really a 2-dimensional problem. In contrast, a quanto option's forward is convexity-adjusted and so depends on volatility, which mixes the dimensions of the sensitivity space [symbol] . If σ_{X} is the volatility of the FX rate and ρ is the correlation between the Brownian motion driving a log normal process for the FX rate and that for the underlying, the at-expiry expected value of the underlying in the Black model is given by

F_{T}′=F_{T}e^{-pσ}^{_{X}}^{σt}=S₀e^{-(r+pσ}^{_{X}}^{σ)t} (76)

### Quanto Delta

Reprojection as described above gives a delta Δ which is the partial derivative of (at-expiry) quanto option value V_{Q} with respect to changes in the convexity-adjusted forward F_{T}′, at constant vega, which is initially unknown. The magnitude and direction of the vega vector is another output of the method. This definition of delta Δ is the natural generalization of equation (3) to convexity-adjusted settings such as a quanto option, and is not the same as simply taking

$${Δ}_{B}^{′} = Φ ( {d}_{1}^{′} ) ≡ Φ ( \frac{1}{σ \sqrt{T}} [ ln ( \frac{{F}_{T}^{′}}{K} ) + \frac{{σ}^{2}}{2} T ] ) \qquad ( 77 )$$

as delta, in which we have simply replaced F_{T} by F^{T}″, in equation (3).

Equation (77) is intuitively appealing because to value a quanto option in the Black model, replacing the forward with equation (76) is correct both F_{T} and F_{T}′ have the same Black volatility. However, the reprojection-based delta Δ_{Q} corresponds to an infinitesimal move in a direction in the space [symbol] that results in maximal change of F_{T}′, whereas the naive delta in equation (77) corresponds to a direction corresponding to constant σ, and because F_{T}′ depends on a through the convexity adjustment in equation (74), by keeping σ fixed, a contribution to the change in F_{T}′ is missed by the equation (77) interpretation. The difference is typically small, but the arbitrage-free replicating portfolio argument that leads to the Black formula in the first place is based on F_{T}′ not F_{T}. Still further, neither of these values are of primary interest for hedging. Instead, the AD sensitivities \vec{∇}V_{Q} represent the most salient information for practical risk management. However, if an objective is to reconcile the information in \vec{∇}V_{Q} with the intuition about option behavior developed in a log normal setting, a systematic method should be applied instead of ad hoc approaches like that leading to equation (77).

For tractability, recognizing that ρ and σ_{X} play the same role, these parameters may be combined into a single variable β=ρσ_{X}, and we may work with F_{T}, given that the description above has already dealt with the effect of separate S₀ and r. The dimensionality of the sensitivity space [symbol] is therefore N=3 and the vector \vec{a} of input parameters is given by \vec{a}=(F_{T},β,σ) with the single underlying

F_{T}′=F_{T}e^{-βσT} (78)

so that the dimensionality M of the underlying sensitivity sub-space [symbol] is 1. The total derivative of V_{Q} is given by

dV_{Q}=Δ_{B}′dF_{T}′+ν_{b}′dσ (79)

where ν_{B}′=\sqrt{T}F_{T}′ϕ(d₁′) and the total derivative of the convexity-adjusted forward is

$${dF}_{T}^{′} = {F}_{T}^{′} [ \frac{{dF}_{T}^{′}}{{F}_{T}} - T ( β d σ + σ d β ) ] \qquad ( 80 )$$

Adopting the notation used above for the description of the geometric re-projection, the gradient vector of V_{Q} in the sensitivity space [symbol] is

\vec{∇}V_{Q}=Δ_{B}′\vec{∇}F_{T}′+ν_{B}′\vec{e_{σ}} (81)

and the gradient vector of the underlying is:

$$\vec{∇} {F}_{T}^{′} = {F}_{T}^{′} [ \frac{\vec{{e}_{{F}_{T}}}}{{F}_{T }} - T ( β \vec{{e}_{σ}} + σ \vec{{e}_{β}} ) ] \qquad ( 82 )$$

Consequently, by equation (19), the delta of the quanto option in the Black model may be determined to be:

$${Δ}_{Q} = \frac{\vec{∇} {V}_{Q} \cdot \vec{∇} {F}_{T}^{′}}{{\vert \vec{∇} {F}_{T }^{′} \vert}^{2}} = {Δ}_{B}^{′} + {v}_{B}^{′} \frac{\vec{{e}_{σ}} \cdot \vec{∇} {F}_{T}^{′}}{{\vert \vec{∇} {F}_{T}^{′} \vert}^{2}} = {Δ}_{B}^{′} + {v}_{B}^{′} \frac{\vec{{e}_{σ}} \cdot \vec{{e}_{{F}_{T}^{′}}}}{\vert \vec{∇} {F}_{T}^{′} \vert} \qquad ( 83 )$$

where the unit vector

$${\vec{e}}_{{F}_{T}^{′}} = \frac{\vec{∇} {F}_{T}^{′}}{\vert \vec{∇} {F}_{T}^{′} \vert} .$$

It can be seen from equation (83) that Δ₀ contains a contribution from ν_{B}′ that depends on the angle between \vec{e}_{σ} and \vec{∇}F_{T}′, which grows from zero with β. That is, when convexity is present in the underlying, delta to the convexity-adjusted forward contains a contribution from the naive vega ν_{B}′.

An explicit form for Δ_{Q} may be obtained by substituting equation (82) into (83). However, to consider both the effect of correlation ρ and FX volatility σ_{X} explicitly, in addition to that of spot S₀ and the interest rate r, the orthonormal basis {\vec{e}_{S}_{₀},\vec{e}ᵣ,\vec{e}_{ρ},e_{σ}_{_{X}},e_{σ}} may be used. For this basis

$$\vec{{e}_{{F}_{T}}} = \frac{\partial {F}_{T}}{\partial {S}_{0}} \vec{{e}_{{F}_{0}}} + \frac{\partial {F}_{T}}{\partial r} \vec{{e}_{r}} = {F}_{T} ( \frac{1}{{S}_{0}} \vec{{e}_{{S}_{0}}} - T \vec{{e}_{r}} ) \\ \vec{{e}_{β }} = \frac{\partial β}{\partial ρ} \vec{{e}_{ρ}} + \frac{\partial β}{\partial {σ}_{X}} \vec{{e}_{{σ}_{X}}} = {σ}_{X} \vec{{e}_{ρ}} + ρ \vec{{e}_{{σ}_{X}}} \qquad ( 84 )$$

while \vec{e}_{σ} remains unchanged. Let L_{T} be defines as

$${L}_{T} = - ln \frac{{F}_{T}^{′}}{{F}_{T}} = β σ T$$

and let ξ be defined as follows

\vec{e_{σ}}·{right arrow over (e_{F}_{_{T}}_{^{′}})}=−βTF_{T} (85)

and |\vec{∇}F_{T}′|²=F_{T}′²ξ² where

$${ξ}^{2} = \frac{1}{{S}_{0}^{2}} = {T}^{2} + {L}_{T}^{2} ( \frac{1}{{ρ}^{2}} + \frac{1}{{σ}_{X}^{2}} + \frac{1}{{σ}^{2}} ) \qquad ( 86 )$$

Substituting equation (86) into equation (83) yields

$${Δ}_{Q} = {Δ}_{B}^{′} - {v}_{B}^{′} \frac{\frac{{F}_{T}^{′} {L}_{T}}{σ}}{{F}_{T}^{′ 2} {ξ}^{2}} = {Δ}_{B}^{′} - \frac{φ ( {d}_{1}^{′} ) β {T}^{3 / 2}}{{ξ}^{2}} \qquad ( 87 )$$

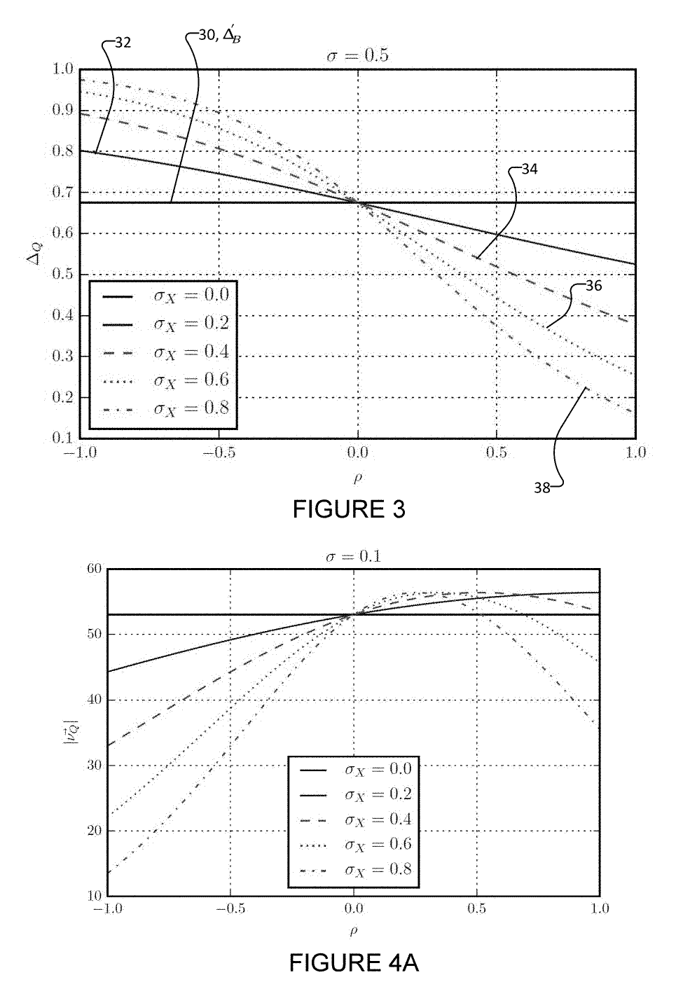

FIG. 3 shows the deviation of delta for a quanto option (Δ_{Q}) from commonly used Δ_{B}′ for a number of FX volatilities (i.e. for a number of σ_{X} values). Each of the curves shown in FIG. 3 shows the delta of a quanto call option in the Black model Δ_{Q} (from equation (87)) as a function of correlation ρ for a particular value of FX volatility σ_{X} with the spot stock price S₀=100, strike K=103, interest rate r=5%, expiry T=2 years and stock volatility σ=50%. Curve 30 shows Δ_{Q} for σ_{X}=0, which corresponds to Δ_{B}′ (equation (77)). Curves 32, 34, 36, 38 respectively depict Δ_{Q} for σ_{X}=0.2, 0.4, 0.6, 0.8. FIG. 3 demonstrates that all of the Δ_{Q} curves intersect at zero correlation (ρ=0), but for non-zero correlation (ρ≠0), Δ_{Q}≠Δ_{B}′ and this difference increases with |ρ| and with σ_{X}.

### Quanto Vega

In terms of the above-discussed quanto example, the equation (48) vega formula reads:

\vec{ν_{Q}}=\vec{∇}V_{Q}−Δ_{Q}\vec{∇}F_{T}′ (88)

Eliminating \vec{∇}V_{Q} using equation (81) gives the vega vector

\vec{ν}_{Q}=(Δ_{B}′−Δ_{Q})\vec{∇}F_{T}′+ν_{B}′\vec{e_{σ}}=ν_{B}′(\vec{e_{σ}}−\vec{e_{σ}}·{right arrow over (e_{F}_{_{T}}_{^{′}})}\vec{e_{σ}}·{right arrow over (e_{F}_{_{T}}_{^{′}})}) (89)

which has a length (using equation (85)) of

$$\vert \vec{{v}_{Q}} \vert = {v}_{B}^{′} \sqrt{1 - {( \frac{β T}{ξ} )}^{2}} \qquad ( 90 )$$

The orthogonality of \vec{ν}_{Q} and \vec{∇}F_{T}′ is particularly clear given equation (89), where

\vec{ν_{Q}}·\vec{∇}F_{T}′=ν_{B}′ξ\vec{e_{σ}}·{right arrow over (e_{F}_{_{T}}_{^{′}})}(1−{right arrow over (e_{F}_{_{T}}_{^{′}})}·{right arrow over (e_{F}_{_{T}}_{^{′}})})=0 (91)

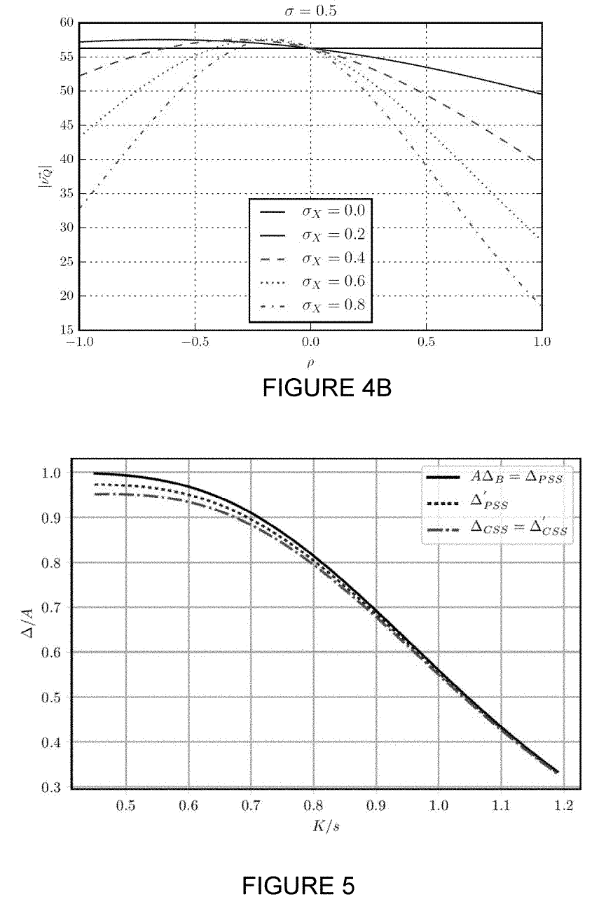

FIGS. 4A and 4B show the deviation of |\vec{ν_{Q}}| from ν_{B}′ as a function of correlation ρ for a number of FX volatilities (i.e. for a number of σ_{X} values). Each of the curves shown in FIG. 4A shows the vega (|\vec{ν_{Q}}|) of a quanto call option in the Black model (from equation (90)) as a function of correlation ρ for a particular value of FX volatility σ_{X} with the spot stock price S₀=100, strike K=103, interest rate r=5%, expiry T=2 years and stock volatility σ=10%. The same curves are shown in FIG. 4B for stock volatility σ=50%. Curve 40A, 40B respectively show vega (|\vec{ν_{Q}}|) for σ_{X}=0, which corresponds to ν_{B}′. The other curves shown in FIGS. 4A and 4B demonstrate that all of the vega (|\vec{ν_{Q}}|) curves intersect at zero correlation (ρ=0), but for non-zero correlation (ρ≠0),|\vec{ν_{Q}}|≠ν_{B}′ and this difference increases with |ρ| and with σ_{X}. Another interesting observation observable from FIGS. 4A and 4B is that, in most of the illustrated parameter space, there is a correlation ρ* for which vega (|\vec{ν_{Q}}|) is maximal.

### Swaptions

The contrast between physically and cash-settled swaptions provides another interesting example. As in the Black-Scholes model for the European call option described above, vega is orthogonal to delta. However, as will be shown below, the contribution to delta from the annuity is captured in a systematic way using the methods described herein.

The at-expiry value of a physically settled European swaption in the Black model is given by:

V=A[Φ(d₁)s−Φ(d₂)K] (92)

where A is the annuity discounted to expiry, s is the forward swap rate, K is the strike, and d_{1,2} are as defined in equation (86), but with the spot S₀ replaced by s and with r=0. For simplicity, the standard market formula for cash-settled swaptions will be used. This formula assumes that equation (92) holds when the physically settled annuity is replaced by the cash-settled annuity. As in the above examples, the dimensionality of the sensitivity space [symbol] is N=3, where \vec{a}=[r,z,σ]^{T} and where r is a parameter describing the risk-free rate, and z is a parameter describing the spread of Libor over this risk-free rate. The single underlying is the forward swap rate s, so the dimensionality M of the underlying sensitivity subspace [symbol] is again M=1.

The exact dependence of the annuity and swap rate on r and z does not need to be made at this point. These simplifying assumptions are only made to clarify the discussion. The reprojection techniques discussed herein still apply when more realistic modeling assumptions are made in fact these reprojection techniques are independent of the valuation model and its implementation, as long as the full set of sensitivities (see equations (5) and (12)) is readily available, as is the case with AD.

In practice, the delta of a swaption can be obtained by differentiating equation (92) with respect to the swap rate s:

$$Δ = A {Δ}_{B} + \frac{V}{A} \frac{\partial A}{\partial s} \qquad ( 93 )$$

The right hand side of equation (93) is the Black-Scholes delta Δ_{B} scaled by the annuity A, plus a correction arising from the dependence of the annuity on the swap rate s. If we choose a model where the annuity is independent of the swap rate, as is common for a physically settled swaption (PSS), this correction term vanishes and Δ_{PSS}=AΔ_{B}. For a cash-settled swaption (CSS) on a swap with n fixed payments paid every α years, the cash-settled annuity is given by

$$A ( s ) = {\sum }_{i = 1}^{n} \frac{n}{{( 1 + α s )}^{i}} = \frac{1}{s} [ 1 - \frac{1}{{( 1 + α s )}^{n}} ] \qquad ( 94 )$$

The equation (94) expression for the cash-settled annuity implies that Δ_{CSS}<AΔ_{B}, because the annuity A is a positive-valued monotonically decreasing function of s.

To apply the reprojection techniques described herein, the usual gradient vectors may be computed according to:

$$\begin{matrix}\vec{∇} V = {( \frac{\partial V}{\partial r} , \frac{\partial V}{\partial z} , \frac{\partial V}{\partial σ} )}^{T} = {A ( Φ ( {d}_{1} ) \frac{\partial s}{\partial r} + \frac{V}{A} \frac{\partial A}{\partial r} , Φ ( {d}_{1} ) \frac{\partial s}{\partial z} + \frac{V}{A} \frac{\partial A}{\partial z} , A \sqrt{t} s φ ( {d}_{1} ) )}^{T} & ( 95 ) \\ \vec{∇} s = {( \frac{\partial s}{\partial r} , \frac{\partial s}{\partial z} , \frac{\partial s}{\partial σ} )}^{T} = {( \frac{\partial s}{\partial r} , \frac{\partial s}{\partial z} , 0 )}^{T} & ( 96 )\end{matrix}$$

where equations (95) and (96) make use of the assumption that A=A(r,z) and s=s(r,z). Substituting equations (95) and (96) into equation (19), the following result is obtained

$${Δ}^{′} = A {Δ}_{B} + \frac{V}{A} \frac{\frac{\partial A}{\partial r} \frac{\partial s}{\partial r} + \frac{\partial A}{\partial z} \frac{\partial s}{\partial z}}{{( \frac{\partial s}{\partial r} )}^{2} + {( \frac{\partial s}{\partial z} )}^{2}} \qquad ( 97 )$$

The residual (vega) vector is obtained by the annuity-scaled Black Scholes result:

\vec{ν}=(0,0,A\sqrt{t}sϕ(d₁)) (98)

which is expected given the orthogonality of delta and vega. Applying the chain rule to the cash-settled swaption annuity gives

$$\frac{\partial A}{\partial x} = \frac{\partial A}{\partial s} \frac{\partial s}{\partial x} \qquad ( 99 )$$

for x=r,z. Substituting these expressions into equation (97) reproduces equation (93). However, in the case of a physically-settled swaption, the two approaches differ by an amount

$${Δ}_{PSS}^{′} - {Δ}_{PSS} = \frac{V}{A} \frac{\frac{\partial A}{\partial r} \frac{\partial s}{\partial r}}{{( \frac{\partial s}{\partial r} )}^{2} + {( \frac{\partial s}{\partial z} )}^{2}} \qquad ( 100 )$$

where Δ_{PSS}=AΔ_{B} (from equation (97)) and the right hand side of equation (100) represents the rightmost term of equation (97) in the case of a physically-settled swaption. While the equation (100) difference is typically small, it is not negligible, particularly for in-the-money physically settled swaptions.

The question then becomes which delta (Δ_{PSS}′ or Δ_{PSS}) is the most representative of the desired delta. Calculating Δ_{PSS}=AΔ_{B} is equivalent to calculating the change in swaption value relative to the change in the underlying swap rate s at constant annuity. In contrast, Δ_{PSS}′ is the change in swaption value relative to the change in the underlying swap rate s at constant vega. Practically speaking, it is unlikely that changes in the swap rate s would be unaccompanied by changes in the risk-free rate r, yet this is what Δ_{PSS} implies. In fact, in any terminal swap rate model, zero-coupon bond prices and therefore the annuity are modeled as functions of the swap rate s. Consequently, a contribution to delta would be obtained from the annuity. Defining delta in terms of reprojection (and, in so doing, determining Δ_{PSS}′ rather than Δ_{PSS}), ensures that any variation of the swaption price that can be attributed to the underlying swap is captured in delta. This surety is further support for the use of a systematic method rather than ad hoc approaches like those leading to equations (96) and (93).

To analyze the correction term in equation (100), a number of simplifying assumptions may be made about the model for the swap rate s, but it should be emphasized that the approach described herein can be applied to any modeling choice for the swap rate s. The zero coupon bond price and Libor accruing curve may be described as

P_{D}(0,t)=e^{-rt}, P_{L}(0,t)=e^{-(r+z)t} (101)

such that the Libor rate is a spread z over the risk-free rate r. Modeling Libor with continuous compounding and assuming that the fixed and floating schedules of the underlying swap have the same frequency and identical payment times, the swap rate is just r+z. The cash-settled swaption delta of equation (97) is then

$${Δ}_{CSS} = A Φ ( {d}_{1} ) + \frac{V}{2 A} ( \frac{\partial A}{\partial r} ) + ( \frac{\partial A}{\partial z} ) \qquad ( 102 )$$

and the correction for the physically-settled swaption is

$${Δ}_{PSS} - {Δ}_{PSS}^{′} = \frac{V}{2 A} \frac{\partial A}{\partial r} \qquad ( 103 )$$

FIG. 5 shows various annuity-scaled swaption deltas

$$( \frac{Δ}{A} )$$

as a function of moneyness (i.e. a ratio of the strike over the swap rate

$$( \frac{K}{s} ) )$$

for me equation (101) simplified model where the interest rate r=5%, the spread is z=1%, the expiry is T=2 years and the swap rate volatility is σ=30%. The physically settled swaption delta (Δ_{PSS}) is just the scaled Black-Scholes result, and the cash-settled swaption delta (Δ_{CSS}) includes the same annuity correction in both the traditional finite difference or novel risk reprojection approaches. Most interestingly, the physically settled swaption delta calculated with risk reprojection (Δ_{PSS}′) contains a correction term arising from the sensitivity of the annuity A to the interest rate r. The size of the correction terms is largest when the swaption is deep “in-the-money”—i.e. when

$$\frac{K}{s}$$

is relatively small.

### Implementation

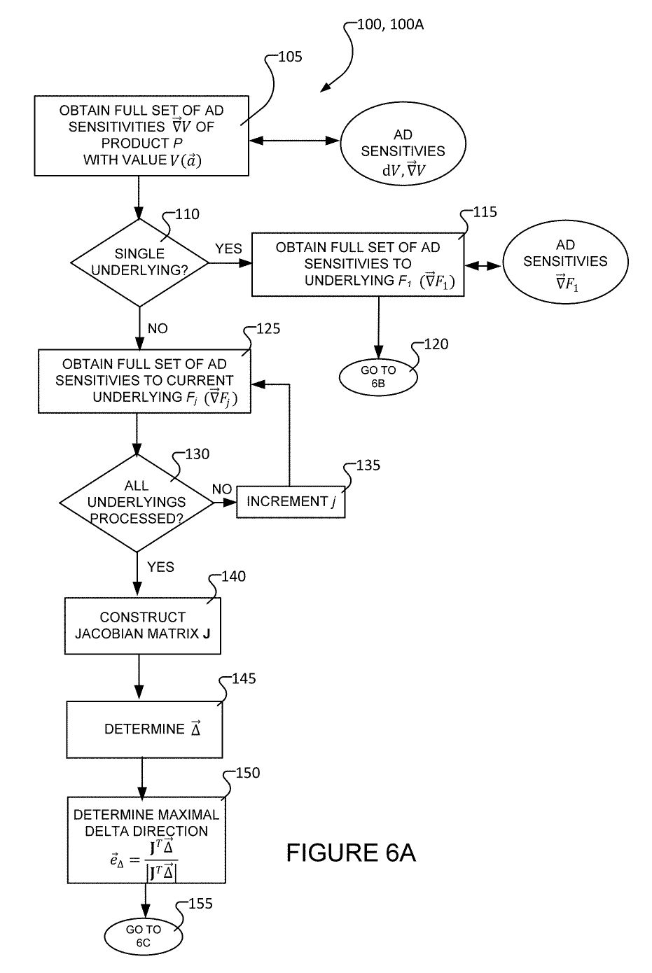

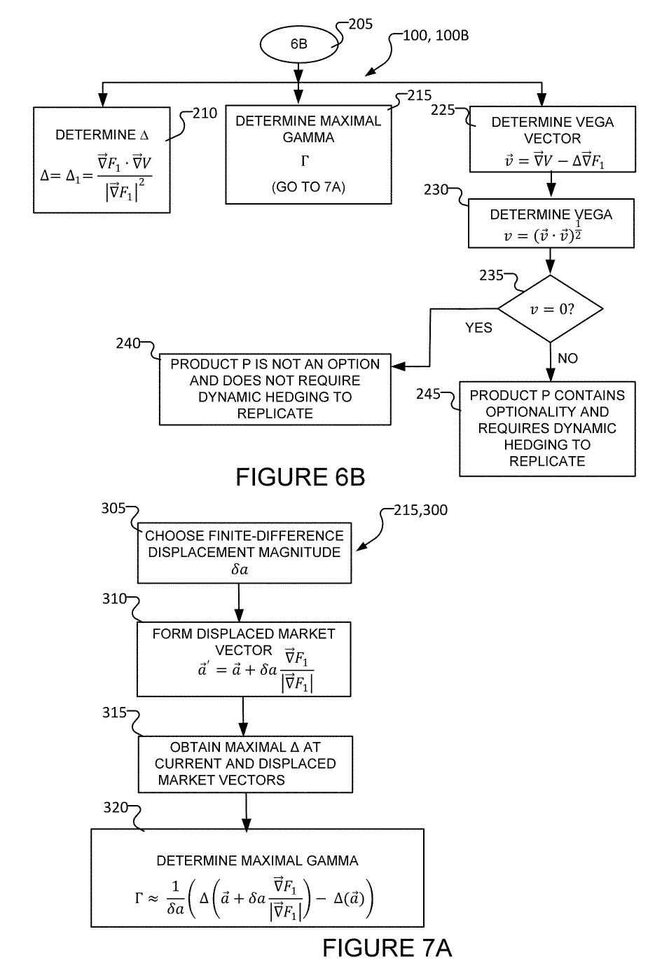

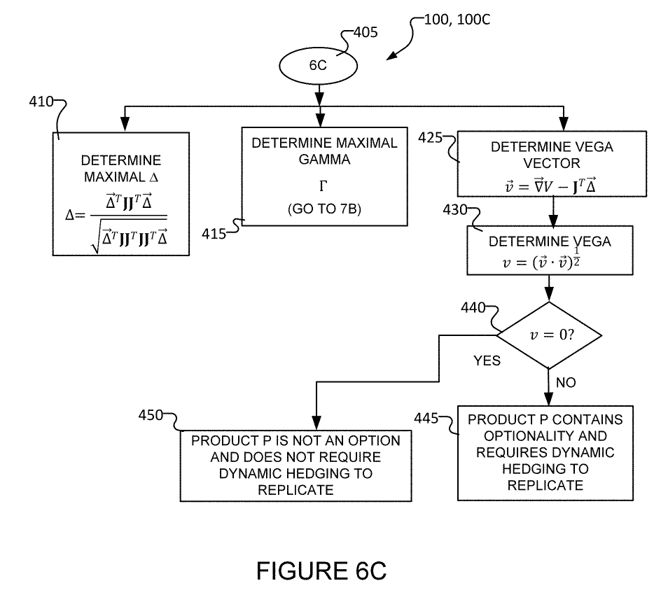

FIGS. 6A, 6B and 6C show a flowchart depiction of a method 100 for determining the option greeks delta, gamma and vega of a product P (e.g. a financial contract) according to a particular embodiment. Method 100 of the illustrated embodiment assumes that the observations of all relevant observables are made no later than expiry of the financial contract. Method 100 starts in portion 100A (FIG. 6A). In block 105, method 100 obtains the full set of AD sensitivities for the product P with a value V(\vec{a}). These AD sensitivities are represented by the expression dV in equation (5) and/or the vector \vec{∇}V described in equation (12)—i.e.

$$\vec{∇} V = {[ \frac{\partial V}{\partial {a}_{1}} , \frac{\partial V}{\partial {a}_{2}} , … \frac{\partial V}{\partial {a}_{N}} ]}^{T} .$$

As discussed above, AD software routines for computing these block 105 AD sensitivities are known in the art. Method 100 then proceeds to block 110, which involves an inquiry into whether the financial contract under consideration involves a single underlying or more than one underlying. For explanatory purposes, method 100 of the illustrated embodiment is shown separately for a single underlying (M=1) and for multiple underlyings (M>1). However, in practice, the method applied for multiple underlyings is generic to evaluating a financial contract with a single underlying. Consequently, in practice, block 110 and the subsequent steps along the block 110 YES branch are not required.

Assuming that there is only one underlying (M=1), then method 100 exits from block 110 along the YES branch and proceeds to block 115. In block 115, method 100 is shown to obtain a full set of AD sensitivities to the single underlying F₁—e.g. \vec{∇}F₁. The block 115 operation may obtain the AD sensitivities \vec{∇}F₁ by performing AD procedures on the single (M=1) underlying F₁ and the output \vec{∇}F₁ of the block 115 operation may be obtained according to

$$d {F}_{1} = \vec{∇} {F}_{1} \cdot d \vec{a} ≡ \vec{∇} {F}_{1}^{T} d \vec{a} = {\sum }_{i = 1}^{N} \frac{\partial {F}_{1}}{\partial {a}_{i}} d {a}_{i} ,$$

which defines \vec{∇}F₁ as a vector with N elements, whose i^{th} element is

$$\frac{\partial {F}_{1}}{\partial {a}_{i}}$$

—i.e.

$$\vec{∇} {F}_{1} = {[ \frac{\partial {F}_{1}}{\partial {a}_{1}} , \frac{\partial {F}_{1}}{\partial {a}_{2}} , … \frac{\partial {F}_{1}}{\partial {a}_{N}} ]}^{T} .$$

As discussed above, AD software routines for computing these block 115 AD sensitivities are known in the art.

Once the block 115 AD sensitivities have been obtained, method 100 proceeds (at block 120) to FIG. 6B (block 205). The portion 100B of method 100 shown in FIG. 6B involves three processes which (in the illustrated embodiment) are shown as being performed in parallel, but which (in some embodiments) may be performed serially. The three processes in portion 100B of method 100 of the illustrated FIG. 6B embodiment include determining delta (Δ), determining vega (ν) and determining gamma (Γ).

In the illustrated embodiment, delta is determined in block 210. As discussed above, for the case where M=1, delta (Δ) may be determined in block 210 using equation (19), which makes use of the block 105 AD sensitivities \vec{∇}V and the block 115 sensitivities \vec{∇}F₁. The value of delta (Δ) may be suitably output to the user as a part of block 210. As discussed above, the operation of block 210 effectively decomposes the block 105 AD sensitivities of V (i.e. \vec{∇}V described in equation (12) which is in the sensitivity space [symbol] ) into two reprojected sensitivity vector components: one (Δ₁\vec{∇}F₁ where Δ₁=Δ) in the underlying sensitivity subspace [symbol] spanned by the single underlying sensitivity vector {\vec{∇}F₁}; and one (\vec{ν}) in the remainder space [symbol] . As also discussed above, this block 210 operation may be understood to be a reprojection of the risk of the contract value V from the vector space [symbol] of the observables {aᵢ} into the subspace [symbol] and the remainder space [symbol] . FIG. 2 shows this block 210 reprojection for the Black-Scholes example discussed above, where M=1, Δ₁=Δ=Δ_{B} and \vec{∇}F₁=\vec{∇}F_{T}.

Vega is determined in the rightmost branch of the FIG. 6B diagram. The determination of vega starts in block 225 which involves determining the vega vector \vec{ν}. The vega vector \vec{ν} may be determined according to equation (15) which, in the case of M=1, reduces to \vec{ν}=\vec{∇}V −Δ\vec{∇}F₁. (where Δ=Δ₁). This equation (15) expression makes use of the block 105 AD sensitivities \vec{∇}V and the block 115 AD sensitivities \vec{∇}F₁. Method 100 then proceeds to block 230, where vega (the scalar quantity ν) is determined. In the illustrated embodiment, vega is determined in block 230 according to ν=(\vec{ν}·\vec{ν})^{1/2}, where this block 230 operation uses the block 225 vega vector \vec{ν}. The value of vega may be suitably output to the user as a part of block 230.

Method 100 then proceeds to block 235 which involves an inquiry into whether vega is zero. If vega is zero, then method 100 proceeds to block 240 which concludes that the product (e.g. financial contract) P being evaluated in method 100 does not include optionality and, consequently, the product P does not require dynamic hedging to replicate (e.g. for risk mitigation purposes). Block 240 may output some suitable indicator that vega is zero or that product P does not contain optionality. The knowledge that a product P does not contain optionality and does not require dynamic hedging may be a useful result for traders and brokers, because this knowledge can save the time and expense (e.g. transactional costs) associated with dynamic hedging. If vega is not zero, then method 100 proceeds from block 235 to block 245 which concludes that the product P contains optionality and requires dynamic hedging to replicate. The block 245 conclusion that vega is non-zero and that the product P contains optionality can be beneficial for managing market risk, for example, where a product P contains hidden optionality which might cause the value V of product P to change in unexpected ways.

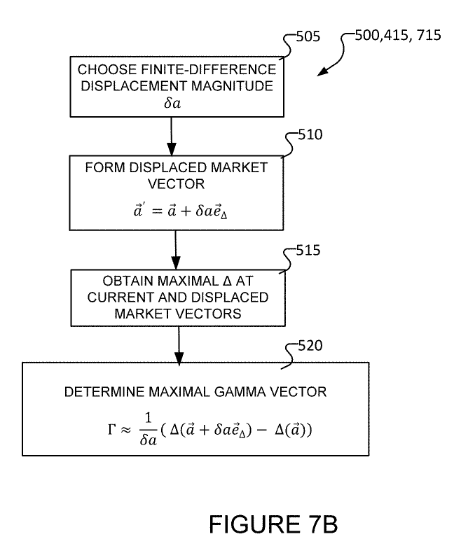

Gamma is determined in the middle branch (block 215) of the FIG. 6B diagram. As discussed above, determination of gamma may involve using a finite difference technique which may operate on the AD sensitivities (e.g. the block 105 AD sensitivities \vec{∇}V and/or the block 115 AD sensitivities \vec{∇}F₁). One example embodiment which may be used for determining gamma in block 215 is shown in the method 300 of FIG. 7A. FIG. 7A method 300 starts in block 305 which involves determining a magnitude of the finite difference displacement δa (i.e. the magnitude of the vector in equation (20D)). In general, it is desirable to provide a finite difference displacement δa that is sufficiently small that it will approximate an infinitesimal without being so small that the result is affected by the finite precision of floating point operations. Then, method 300 proceeds to block 310, which involves determining the displaced market vector \vec{a}′ for the block 305 the finite difference displacement \vec{δ}a. The displaced market vector \vec{a}′ may be determined in block 310 using the expression

$${\vec{a}}^{′} = \vec{a} + δ a \frac{\vec{∇} {F}_{1}}{\vert \vec{∇} {F}_{1} \vert}$$

which makes use of the block 115 reprojected AD sensitivities \vec{∇}F₁. Notably, the direction of the block 310 displacement (in the

$$\frac{\vec{∇} {F}_{1}}{\vert \vec{∇} {F}_{1} \vert}$$

direction) is chosen to be the maximal delta direction \vec{e}_{Δ} where \vec{e}_{Δ} (given by equation (22) in the general case) reduces

$$\frac{\vec{∇} {F}_{1}}{\vert \vec{∇} {F}_{1} \vert}$$

in the M=1 case.

Method 300 then proceeds to block 315 which involves determining maximal Δ for the current market vector \vec{a} and for the block 310 displaced market vector \vec{a}′. In the single underlying (M=1) case, this block 315 procedure may be the same as the procedure of block 210 (FIG. 6B) for both the current market vector \vec{a} and the block 310 displaced market vector \vec{a}′. In general, however, any of the techniques described herein for determining maximal Δ may be used in block 315. Method 300 may then proceed to block 320 which involves determining scalar gamma. Block 320 may determine scalar gamma according to equation (39B), which, in the case of M=1, reduces to

$$Γ \approx \frac{1}{δ a} ( Δ ( \vec{a} + δ a \frac{\vec{∇} {F}_{1}}{\vert \vec{∇} {F}_{1} \vert} ) - Δ ( \vec{a} ) ) .$$

The gamma determined in block 320 may be referred to as maximal gamma, since it is determined using maximal delta, where maximal delta has the meaning described above.

In the illustrated embodiment of FIG. 7A, the finite difference displacement δa is in the maximal delta direction and maximal delta Δ is explicitly determined in block 315 for both the current market vector \vec{a} and the block 310 displaced market vector \vec{a}′. In some embodiments, other techniques may additionally or alternatively be used to compute maximal gamma. For example, the direction of the finite difference displacement δa may be arbitrary in the sensitivity space [symbol] (e.g. in the form of equation (20D)) or maximal gamma may be determined using the individual underlying deltas {Δⱼ} according to equations (38) and (39). It will be appreciated that for the M=1 case, there is only one such underlying delta Δ₁=Δ and the maximal delta direction \vec{e}_{Δ} reduces to

$$\frac{\vec{∇} {F}_{1}}{\vert \vec{∇} {F}_{1} \vert}$$

and so equations (38) and (39) reduce to those shown in FIG. 7A.

Returning to FIG. 6B, the block 320 maximal gamma may be suitably output to a user as part of block 215.

Returning to FIG. 6A (block 110), method 100 is now explained for the case where M>1. For the case where M>1, the procedural steps in method 100 are similar to those discussed above for the case where M=1, except that they may be computationally more complex due to the increased dimensionality of the underlying space. If M>1, then method 100 proceeds from block 110 to block 125. Block 125 (together with blocks 130 and 135) implement a loop that is analogous to block 115 discussed above and involves determining the AD sensitivities \vec{∇}Fⱼ of the underlyings Fⱼ for each j=1 . . . M. The operations in the loop of blocks 125, 130 and 135 may obtain the AD sensitivities \vec{∇}Fⱼ by performing AD procedures on each underlying Fⱼ and the output \vec{∇}Fⱼ of the operations of blocks 125, 130 and 135 may be obtained according to

$$d {F}_{j} = \vec{∇} {F}_{j} \cdot d \vec{a} ≡ \vec{∇} {F}_{j}^{T} d \vec{a} = {\sum }_{i = 1}^{N} \frac{\partial {F}_{j}}{\partial {a}_{i}} d {a}_{i}$$

for each j=1 . . . M, which defines \vec{∇}Fⱼ as a vector with N elements, whose i^{th} element is

$$\frac{\partial {F}_{j}}{\partial {a}_{i}}$$

—i.e.

$$\vec{∇} {F}_{j} = {[ \frac{\partial {F}_{j}}{\partial {a}_{1}} , \frac{\partial {F}_{j}}{\partial {a}_{2}} , … \frac{\partial {F}_{j}}{\partial {a}_{N}} ]}^{T}$$

for each j=1 . . . M. As discussed above, AD software routines for computing these AD sensitivities in the loop of blocks 125, 130, 135 are known in the art.

Once the AD sensitivities \vec{∇}Fⱼ of the underlyings Fⱼ for each j=1 . . . M have been determined in the loop of blocks 125, 130 and 135, method 100 proceeds to block 140 which involves constructing the Jacobian matrix J. As discussed above, the jth column of J^{T} is \vec{∇}Fⱼ, so construction of the Jacobian matrix J in block 140 is relatively straightforward. Once the Jacobian matrix J is ascertained, method 100 proceeds to block 145 which involves determining the vector delta (\vec{Δ}). Block 145 may involve the use of equation (18), which is the solution to equation (15), and may involve performing a linear regression operation which minimizes \vec{ν}·\vec{ν} or the sum of squares of the {νᵢ}, as discussed above in connection with equations (16) and (17). As discussed above, equation (15) and the corresponding operation of block 145 decomposes the block 105 AD sensitivities of V (i.e. \vec{∇}V described in equation (12) which are in the sensitivity space [symbol] ) into two reprojected sensitivity vector components: one (J^{T}\vec{Δ}=Σⱼ₌₁^{M}Δⱼ\vec{∇}Fⱼ) in the underlying sensitivity subspace [symbol] spanned by the vectors {\vec{∇}Fⱼ}; and one (\vec{ν}) in the remainder space [symbol] . FIG. 1 shows an example of this block 145 reprojection for the case where M=2.

Once vector delta (\vec{Δ}) is determined in block 145, method 100 proceeds to block 150 which involves determining the direction of the block 145 delta vector (\vec{Δ}) or, equivalently, determining the unit vector \vec{e}_{Δ} whose direction is the same as the direction of the block 145 delta vector (\vec{Δ})—i.e. the unit vector \vec{e}_{Δ} in the maximal delta direction. Block 145 may involve determining the unit vector \vec{e}_{Δ} in accordance with equation (22).

After block 150, method 100 proceeds (at block 155) to FIG. 6C (block 405). The portion 100C of method 100 shown in FIG. 6C involves three processes which (in the illustrated embodiment) are shown as being performed in parallel, but which (in some embodiments) may be performed serially. The three processes in portion 100C of method 100 of the illustrated FIG. 6C embodiment include determining delta (Δ), determining vega (ν) and determining gamma (Γ). In the illustrated embodiment, delta is determined in the leftmost branch of the FIG. 6C diagram. Determining delta occurs in block 410 which involves determining the scalar delta (Δ). The scalar delta Δ (also referred to herein as the maximal delta) may be determined in block 410 according to equation (34). In some embodiments, maximal delta may additionally or alternatively be determined according to Δ=Σⱼ₌₁^{M} Δⱼ. The value of maximal delta (Δ) may be suitably output to the user as a part of block 410.

Vega is determined in the rightmost branch of the FIG. 6C diagram. The determination of vega starts in block 425 which involves determining the vega vector \vec{ν}. The vega vector \vec{ν} may be determined according to equation (48) which makes use of the block 105 AD sensitivities \vec{∇}V and the block 140 Jacobian matrix J. Method 100 then proceeds to block 430, where vega (the scalar quantity ν) is determined in the same manner as discussed above, in connection with block 230. The value of vega may be suitably output to the user as a part of block 430. Method 100 then proceeds to block 440 and one of blocks 445 or 450. The procedures of blocks 440, 445, 450 are the same as those of blocks 235, 240, 245 discussed above.

Gamma (maximal gamma) is determined in the middle branch (block 415) of the FIG. 6C diagram. As discussed above, determination of maximal gamma may involve using a finite difference technique which may operate on the AD sensitivities (e.g. the block 105 AD sensitivities \vec{∇}V and/or the block 125 AD sensitivities \vec{∇}Fⱼ and/or the block 140 Jacobian matrix J made up of the block 125 AD sensitivities \vec{∇}Fⱼ. One example embodiment which may be used for determining maximal gamma in block 415 is shown in the method 500 of FIG. 7B. FIG. 7B method 500 starts in block 505 which involves determining a magnitude of the finite difference displacement δa and which may be the same as block 305 of method 300 (FIG. 7A) discussed above. Then, method 500 proceeds to block 510, which involves determining the displaced market vector \vec{a}′ for the block 505 the finite difference displacement δa. The displaced market vector \vec{a}′ may be determined in block 510 using the expression \vec{a}′=\vec{a}+δa\vec{e}_{Δ}, where the finite difference displacement δa is directed in the block 150 maximal delta direction \vec{e}_{Δ}. Method 500 then proceeds to block 515 which involves determining maximal Δ for the current market vector \vec{a} and for the block 510 displaced market vector \vec{a}′. This block 515 procedure may be the same as the procedure of block 410 (FIG. 6C) and may involve the use of equation (34) for both the current market vector \vec{a} and the block 510 displaced market vector \vec{a}′. In general, however, any of the techniques for determining maximal delta may be used in block 515. Method 500 may then proceed to block 520 which involves determining maximal gamma. Block 520 may determine maximal gamma according to equation (39B)—i.e.

$$Γ \approx \frac{1}{δ a} ( Δ ( \vec{a} + δ a {\vec{e}}_{Δ} ) - Δ ( \vec{a} ) ) .$$

The gamma determined in block 520 may be referred to as maximal gamma, since it is determined using maximal delta, where maximal delta has the meaning described above.

In the illustrated embodiment of FIG. 7B, the finite difference displacement δa is in the maximal delta direction \vec{e}_{Δ} and maximal delta Δ is explicitly determined in block 515 for both the current market vector \vec{a} and the block 510 displaced market vector \vec{a}′. In some embodiments, other techniques may additionally or alternatively be used to compute gamma. For example, the direction of the finite difference displacement δa may be arbitrary in the sensitivity space [symbol] (e.g. in the form of equation (20D)) or maximal gamma may be determined using the individual underlying deltas {Δⱼ} according to equations (38) and (39).

Returning to FIG. 6C, the block 520 maximal gamma may be suitably output to a user as part of block 415.

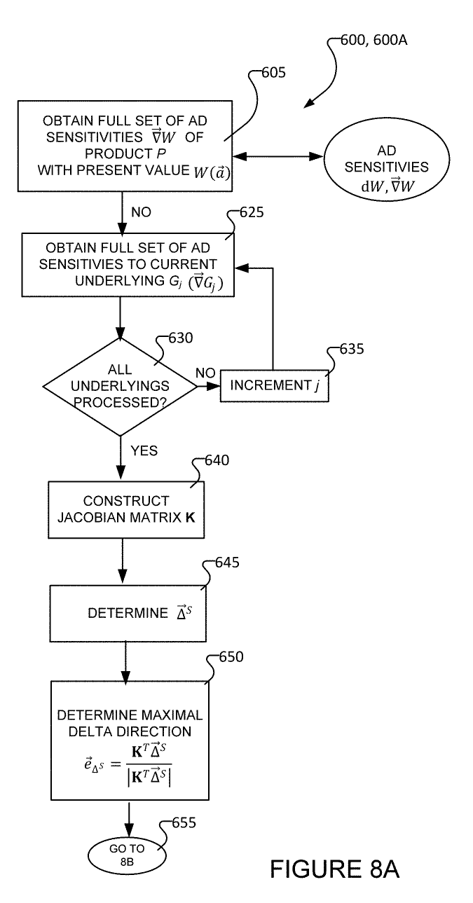

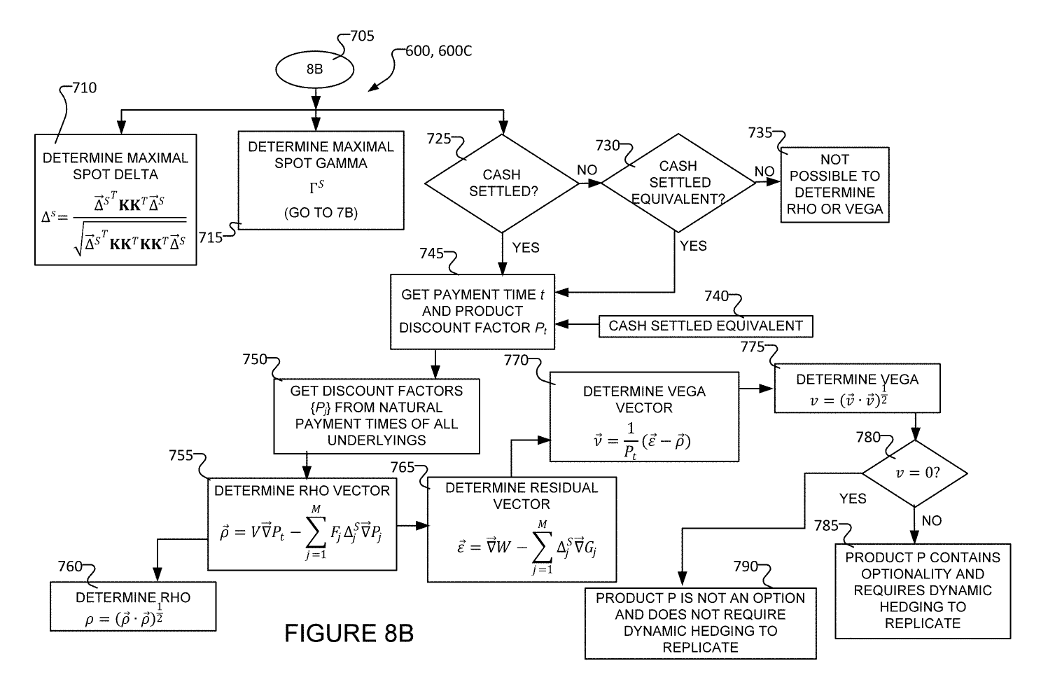

FIGS. 8A and 8B show a flowchart depiction of a method 600 for determining the option greeks delta, gamma and vega of a product P (e.g. a financial contract) according to another particular embodiment. Method 600 is similar to method 100 described above and similar or analogous functional blocks of method 600 are given reference numerals that are similar to those of method 100, except that the functional blocks of method 600 have reference numerals that are greater, by 500, than those of method 100. Method 600 differs from method 100 in that method 600 works with the present values (rather than the at-expiry values) of the product P and its underlyings. This, working in the present value, allows determination of the option greek known as rho which is a measure of sensitivity to interest rates. Method 600 of the illustrated embodiment also differs from method 100 because separate functionality for the M=1 case is not shown explicitly, since the methodology for M>1 also applies for M=1. Method 600 starts in portion 600A (FIG. 8A). In block 605, method 600 obtains the full set of AD sensitivities for the product P with a present value W(\vec{a}). It will be appreciated that the present value W(\vec{a}) of block 605 is related to the block at-expiry value V(\vec{a}) by equation (51). The block 605 AD sensitivities are represented by the expression

$$d W = {\sum }_{i = 1}^{N} \frac{\partial W}{\partial {a}_{i}} d {a}_{i}$$

(e.g. the present value analog of equation (5)) and/or the vector

$$\vec{∇} W = {[ \frac{\partial W}{\partial {a}_{1}} , \frac{\partial W}{\partial {a}_{2}} , … \frac{\partial W}{\partial {a}_{N}} ]}^{T}$$

(e.g. the present value analog to equation (12)). As discussed above, AD software routines for computing these block 605 AD sensitivities are known in the art.

Method 600 then proceeds to block 625. Block 625 (together with blocks 630 and 635) implement a loop that is analogous to that of blocks 125, 130, 135 of method 100 described above. This loop involves determining the AD sensitivities \vec{∇}Gⱼ of the present value of the underlyings Gⱼ for each j=1 . . . M. The operations in the loop of blocks 625, 630 and 635 may obtain the AD sensitivities \vec{∇}Gⱼ by performing AD procedures on each underlying Gⱼ and the output \vec{∇}Gⱼ of the operations of blocks 625, 630 and 635 may be obtained according to

$${dG}_{j} = \vec{∇} {G}_{j} \cdot d \vec{a} ≡ \vec{∇} {G}_{j}^{T} d \vec{a} = {\sum }_{i = 1}^{N} \frac{\partial {G}_{j}}{\partial {a}_{i}} {da}_{i}$$

for each j=1 . . . M, which defines \vec{∇}Gⱼ as a vector with N elements, whose i^{th} element is

$$\frac{\partial {G}_{j}}{\partial {a}_{i}}$$

—i.e.

$$\vec{∇} {G}_{j} = {[ \frac{\partial {G}_{j}}{\partial {a}_{1}} , \frac{\partial {G}_{j}}{\partial {a}_{2}} , … \frac{\partial {G}_{j}}{\partial {a}_{N}} ]}^{T}$$

for each j=7 . . . M. As discussed above, AD software routines for computing these AD sensitivities in the loop of blocks 125, 130, 135 are known in the art.

Once the AD sensitivities \vec{∇}G of the present values of the underlyings Gⱼ for each j=1 . . . M have been determined in the loop of blocks 625, 630 and 635, method 600 proceeds to block 640 which involves constructing the Jacobian matrix K. As described above in equation (61), the jth column of K^{T} is \vec{∇}Gⱼ, so construction of the Jacobian matrix K in block 640 is relatively straightforward. Once the Jacobian matrix K is ascertained, method 600 proceeds to block 645 which involves determining the vector spot delta (\vec{Δ}^{S}). Block 645 may involve the use of equation (60), which is the solution to equation (58), and may involve performing a linear regression operation which minimizes \vec{ε}·\vec{ε} or the sum of squares of the {εᵢ}. Equation (58) and the corresponding operation of block 645 decomposes the block 605 AD sensitivities of W (i.e. \vec{∇}W which are obtained in block 605 and which are in the spot sensitivity space [symbol] ^{S}) into two reprojected sensitivity vector components: one (Σⱼ₌₁^{M}Δⱼ^{S}\vec{∇}Gⱼ) in the underlying sensitivity subspace [symbol] spanned by the vectors {\vec{∇}Gⱼ}; and one (\vec{ε}) in the remainder space [symbol] .

Once vector spot delta (\vec{Δ}^{S}) is determined in block 645, method 100 proceeds to block 650 which involves determining the direction of the block 645 spot delta vector (\vec{Δ}^{S}) or, equivalently, determining the unit vector \vec{e}_{Δ}_{^{S}} whose direction is the same as the direction of the block 645 spot delta vector (\vec{Δ}^{S})—i.e. the unit vector \vec{e}_{Δ}_{^{S}} in the maximal spot delta direction. Block 645 may involve determining the unit vector \vec{e}_{Δ}_{^{S}} in accordance with

$${\vec{e}}_{{Δ}^{S}} = \frac{{K}^{T} {\vec{Δ}}^{S}}{\vert {K}^{T} {\vec{Δ}}^{S} \vert} = \frac{{\sum }_{j = 1}^{M} {Δ}_{j}^{S} \vec{∇} {G}_{j}}{\vert {\sum }_{j = 1}^{M} {Δ}_{j}^{S} \vec{∇} {G}_{j} \vert} \qquad ( 104 )$$

which is the present value analog of equation (22).

After block 650, method 600 proceeds (at block 655) to FIG. 8B (block 605). The portion 600C of method 600 shown in FIG. 8B involves three processes which (in the illustrated embodiment) are shown as being performed in parallel, but which (in some embodiments) may be performed serially. The three processes in portion 600C of method 600 of the illustrated FIG. 8B embodiment include determining maximal spot delta (Δ^{S}), determining maximal spot gamma (Γ^{S}) and determining rho (p) and vega (ν). In the illustrated embodiment, maximal spot delta Δ^{S} is determined in the leftmost branch of the FIG. 8B diagram. Determining maximal spot delta Δ^{S} occurs in block 710 and may be determined according to

$${Δ}^{S} = \frac{{\vec{Δ}}^{{S}^{T}} {KK}^{T} {\vec{Δ}}^{S}}{\sqrt{{\vec{Δ}}^{{S}^{T}} {KK}^{T} {KK}^{T} {\vec{Δ}}^{S}}} \qquad ( 105 )$$

which may be recognized as the present value analog of equation (34). The value of maximal spot delta (Δ^{S}) may be suitably output to the user as a part of block 710.

Maximal spot gamma, Γ^{S}, is determined in the middle branch (block 715) of the FIG. 8B diagram. Gamma may be determined in block 715 according to method 500 (FIG. 7B) described above, except that the at-expiry expressions that are described in method 500 may be replaced with present value terms. In particular, determining maximal spot gamma, Γ^{S}, in block 715 may involve using a finite difference technique which may operate on the AD sensitivities (e.g. the block 605 AD sensitivities \vec{∇}W and/or the block 625 AD sensitivities \vec{∇}Gⱼ and/or the block 640 Jacobian matrix K made up of the block 625 AD sensitivities \vec{∇}Gⱼ. In one example embodiment, determining maximal spot gamma Γ^{S} in block 715 involves: determining a magnitude of the finite difference displacement δa (analogous to block 505); determining the displaced market vector \vec{a}′ (in a manner analogous to block 510, which may involve using the expression \vec{a}′=\vec{a}+δa\vec{e}_{Δ}_{^{S}}, where the finite different displacement is in the maximal spot delta direction \vec{e}_{Δ}_{^{S}} determined in block 650); determining maximal spot delta Δ^{S} for both the current market vector \vec{a} and the displaced market vector \vec{a}′ (in a manner analogous to block 515, except using the block 710 present value expression of equation (105)); and determining maximal gamma in a manner analogous to block 520, except using the present value analog of equation (39B):

$${Γ}^{S} \approx \frac{1}{δ a} ( Δ ( \vec{a} + δ a {\vec{e}}_{{Δ}^{S}} ) - Δ ( \vec{a} ) ) \qquad ( 106 )$$

As was the case with finite difference techniques discussed in relation to FIGS. 7A and 7B above, other techniques may additionally or alternatively be used to compute maximal spot gamma. For example, the direction of the finite difference displacement δa may be arbitrary in the spot sensitivity space [symbol] ^{S} (e.g. in the present value form of equation (20D)) or maximal spot gamma may be determined using the individual underlying spot deltas {Δⱼ^{S}} according to present value analogs of equations (38) and (39).

Maximal gamma may be suitably output to a user as part of block 715.

The rightmost branch of method 600C involves a determination of rho (ρ) and vega (υ). This portion of method 600C starts in block 625 which involves an inquiry into whether the product P is cash-settled or physically-settled. As is known in the field of derivative trading and valuation, a cash-settled product makes a single payment whose amount is calculated by a payoff function which encapsulates all of the contract's complexity, whereas a physically-settled product results in delivery of assets which themselves may make several payments. This means that for a physically-settled product, it is not possible, in general, to identify the single time tin the discount factor in equation (51). If the product is a physically-settled product (block 725 NO output branch), then method 700C proceeds to block 730 which involves an inquiry into whether there exists a cash-settled equivalent for the financial contract. A cash-settled equivalent to a given financial contract may be provided by a user (e.g. a quantitative analyst), for example. If the block 730 inquiry is negative (i.e. there is no available cash-settled equivalent or it is otherwise not possible to form a cash-settled equivalent to the contract P), then method 600C proceeds to block 735. In block 735, it is recognized that the methods described herein will not be usable to determine rho or vega. Block 735 may comprise providing an output indicating that rho and vega cannot be ascertained.

If the block 730 inquiry is positive, then method 700 proceeds to block 745 which makes use of the available cash-settled equivalent (P*) 740 to the financial product P. If the block 730 inquiry is positive, then the remainder of method 600C may be performed using the cash-settled equivalent contract (P*) 740. For brevity, however, method 600 is described herein in relation to a single product P (it being understood that if the block 730 inquiry is positive, then P* is used in the place of P).

Whether through the block 725 YES branch or through block 740, method 600C ends up in block 745. Block 745 involves determining the payment time t and the discount factor Pₜ for the financial product P. Method 600C then proceeds to block 750 which involves determining the discount factors Pⱼ for all of the underlyings j=1 . . . M from their respective natural payment times to the payment time t. Once these discount factors from blocks 745 and 750 are known, method 600C proceeds to block 755, which involves determining the rho vector (\vec{ρ}). As shown in FIG. 8B, the rho vector \vec{ρ} may be determined in block 755 using equation (63). Once the rho vector \vec{ρ} is determined in block 755, the rho scalar (or just rho) ρ may be determined in block 760 according to ρ=(\vec{ρ·}\vec{ρ})^{1/2}. The value of rho ρ determined in block 760 may be suitably output to a user as part of block 760.

Method 765 proceeds to block 765, which involves determining the residual vector \vec{ε}. Determining the residual vector \vec{ε} in block 765 may involve the use of equation (58), suitably re-arranged to solve for \vec{ε}. Vega vector \vec{υ} may then be ascertained in block 770. The block 770 determination of vega vector \vec{υ} may involve the use of equation (64), suitably re-arranged to solve for \vec{υ}. Once vega vector \vec{υ} is known, then scalar vega ν may be determined in block 775 according to ν=(\vec{ν·}\vec{ν})^{1/2}. The value of vega ν may be suitably output to a user as part of block 760.

The remainder of method 600C (blocks 780, 785, 790) may be the same as blocks 440, 445, 450 of method 100C (FIG. 6C) described above, and involve ascertaining whether vega ν is zero and, if so, concluding that the product P does not contain optionality (and does not require dynamic hedging) or, if not, concluding that the product P does contain optionality. The results of the block 780 inquiry may be suitably output to a user.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

Software and other modules may reside on servers, workstations, personal computers, tablet computers, image data encoders, image data decoders, PDAs, color-grading tools, video projectors, audio-visual receivers, displays (such as televisions), digital cinema projectors, media players, and other devices suitable for the purposes described herein. Those skilled in the relevant art will appreciate that aspects of the system can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics (e.g., video projectors, audio-visual receivers, displays, such as televisions, and the like), set-top boxes, color-grading tools, network PCs, mini-computers, mainframe computers, and the like.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors may implement methods as described herein by executing software instructions in a program memory accessible to the processors.

While processes or blocks described herein are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

### OBSERVATIONS AND CONCLUSIONS

The methods presented reconcile two contrasting approaches to calculating the so-called Greeks for financial contracts that include options. The Greeks characterize the sensitivity of the financial contracts to underlying parameters and are desirable for hedging the financial contracts. Textbook formulae which exist for particular theoretical types of options are a central pillar of option traders' intuitive understanding of how options relate to the markets in which they and their underlying assets are traded, but such formulae lack the detail present in real models and are only available for a subset of models and implementations thereof and for particular types of option. Through the technique of Algorithmic Differentiation, modern analytics libraries make available detailed sensitivities (e.g. the full set of sensitivities described in equations (5) and (12)) which express sensitivity to every quote or parameter used in any type of valuation of the financial contract. Using AD, such sensitivities may be calculated at a computational cost comparable to valuation itself. While such a level of detail may be optimal for calculating real hedges that are possible in a given market, it is inherently numerical and can be relatively difficult to comprehend as a means of understanding option behavior.

Techniques described herein comprise moving from the typically high-dimensional space of all sensitivities of a real financial contract to the key Greeks (e.g. delta and vega) that characterize option behavior, based on reprojecting the full set of sensitivities (e.g. the equation (5)/(12) sensitivities \vec{∇}V) onto the sensitivities of the financial contract's underlyings (e.g. \vec{∇}Fⱼ for j=1, . . . M where M is the number of underlyings). In doing so, a new geometric interpretation of delta and vega is obtained wherein the new delta and vega are reprojected to be expressed in terms of orthogonal components (e.g. the equation (15) components J^{T}\vec{Δ}=Σⱼ₌₁^{M}Δⱼ\vec{∇}Fⱼ and \vec{ν}) of the of full risk vector (e.g. \vec{∇}V) of the financial contract, where the orthogonal components are orthogonal as expressed in equation (16) and the magnitude of the component \vec{ν} (e.g. |\vec{ν}|) is minimized. The reprojection method is model-independent and works for any type of payoff where it is possible to identify a collection of observations which represent the underlyings of the financial contract. The reprojection method makes use of the full set of sensitivities for both option and underlying observations (e.g. the equation (5)/(12) sensitivities). Historically this full set of sensitivities would have been challenging to obtain, but with the advent of systems incorporating AD, such systems typically have, or are easily capable of obtaining, this full set of sensitivities.

Computing delta and vega by reprojection gives results that reduce to standard formulae for a number of special cases, as shown herein. However, when the financial contract and its underlyings share dependence on the same variables, some important differences emerge between reprojection and traditional approaches to calculating Greeks. By way of non-limiting example, in the case of a quanto option in the Black model, where both delta and vega receive a convexity correction, and in the case of swaptions, where the role played by the annuity can be analyzed consistently, resulting in a correction to delta in the physical settled case.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A method for determining a parameter delta Δ which expresses a dependence of an expected value V of a financial contract on one or more underlyings of the financial contract, the method comprising:
obtaining, by a processor, a computer representation of a complete set of algorithmic differentiation (AD) sensitivities of the expected value V of the financial contract to a set of N input parameters \vec{a} in a form
$$\vec{∇} V = {[ \frac{\partial V}{\partial {a}_{1}} , \frac{\partial V}{\partial {a}_{2}} , … \frac{\partial V}{\partial {a}_{N}} ]}^{T}$$
or a mathematical equivalent thereof;
obtaining, by a processor, a computer representation of a complete set of AD sensitivities of the expected value of the one or more underlyings Fⱼ for j=1 . . . M, where M<N and M is a number of the one or more underlyings, to the set of N input parameters \vec{a} in a form
$$\vec{∇} {F}_{j} = {[ \frac{\partial {F}_{j}}{\partial {a}_{1}} , \frac{\partial {F}_{j}}{\partial {a}_{2}} , … \frac{\partial {F}_{j}}{\partial {a}_{N}} ]}^{T}$$
for each j=1 . . . M or a mathematical equivalent thereof;
reprojecting, by the processor, the full set of AD sensitivities \vec{∇}V of the expected value of the financial contract onto the full set of AD sensitivities \vec{∇}Fⱼ for j=1 . . . M of the one or more underlyings to obtain a computer representation of reprojected sensitivity vectors; and
determining, by the processor, the parameter delta Δ based on the computer representation of the reprojected sensitivity vectors.

2. A method according to claim 1 wherein reprojecting the full set of AD sensitivities \vec{∇}V of the expected value of the financial contract onto the full set of AD sensitivities \vec{∇}Fⱼ for j=1 . . . M of the one or more underlyings to obtain the computer representation of reprojected sensitivity vectors comprises decomposing, by the processor, the full set of AD sensitivities \vec{∇}V of the expected value of the financial contract into a computer representation of a pair of orthogonal reprojected sensitivity vectors.

3. A method according to claim 2 wherein decomposing the full set of AD sensitivities \vec{∇}V of the expected value of the financial contract into the computer representation of the pair of orthogonal reprojected sensitivity vectors comprises:
decomposing, by the processor, the full set of AD sensitivities \vec{∇}V of the expected value of the financial contract into the computer representation of the pair of orthogonal reprojected sensitivity vectors comprising J^{T}\vec{Δ}=Σⱼ₌₁^{M}Δⱼ\vec{∇}Fⱼ and \vec{ν}, where the j^{th} column of J^{T} is \vec{∇}Fⱼ; and
selecting, by the processor, the coefficients Δⱼ to minimize |\vec{ν}|.

4. A method according to claim 3 wherein selecting the coefficients Δⱼ to minimize |\vec{ν}| comprises performing, by the processor, linear regression which minimizes \vec{ν}·\vec{ν}.

5. A method according to claim 3 wherein determining the parameter delta Δ based on the computer representation of the reprojected sensitivity vectors comprises determining, by the processor, the parameter delta Δ in accordance with Δ=Σⱼ₌₁^{M}Δⱼ.

6. A method according to claim 2 wherein the number M of underlyings is M=1 and wherein decomposing the full set of AD sensitivities \vec{∇}V of the expected value of the financial contract into the computer representation of the pair of orthogonal reprojected sensitivity vectors comprises:
decomposing, by the processor, the the full set of AD sensitivities \vec{∇}V of the expected value of the financial contract into the computer representation of the pair of orthogonal reprojected sensitivity vectors comprising Δ₁\vec{∇}F₁ and \vec{ν}; and
determining, by the processor,
$${Δ}_{1} = \frac{\vec{∇} {F}_{1} \cdot \vec{∇} V}{{\vert \vec{∇} {F}_{1} \vert}^{2}} .$$

7. A method according to claim 6 wherein determining the parameter delta Δ based on the computer representation of the reprojected sensitivity vectors comprises determining, by the processor, the parameter delta Δ in accordance with Δ=Δ₁.

8. A method according to claim 3 comprising determining, by the processor, a direction of the reprojected sensitivity vector J^{T}\vec{Δ}=Σⱼ₌₁^{M}Δⱼ\vec{∇}Fⱼ.

9. A method according to claim 8 wherein determining the direction of the reprojected sensitivity vector J^{T}\vec{Δ}=Σⱼ₌₁^{M}Δⱼ\vec{∇}Fⱼ comprises determining, by the processor, a computer representation of a unit vector \vec{e}_{Δ} in the direction of the reprojected sensitivity vector J^{T}\vec{Δ}=Σⱼ₌₁^{M}Δⱼ\vec{∇}Fⱼ.

10. A method according to claim 1 further comprising determining, by the processor, a parameter vega ν which expresses a dependence of the expected value V of the financial contract to any volatilities which may be present in the one or more underlyings Fⱼ for j=1 . . . M based at least in part on the computer representation of the reprojected sensitivity vectors.

11. A method according to claim 3 further comprising determining, by the processor, a parameter vega ν which expresses a dependence of the expected value V of the financial contract to any volatilities which may be present the one or more underlyings Fⱼ for j=1 . . . M according to ν=(\vec{ν} ·\vec{ν})^{1/2}.

12. A method according to claim 10 comprising determining, by the processor, that the parameter vega ν is zero and outputting, by the processor, an indication that the financial contract does not have optionally.

13. A method according to claim 10 comprising determining, by the processor, that the parameter vega ν is non-zero and outputting, by the processor, an indication that the financial contract does have optionally.

14. A method according to claim 1 further comprising determining, by the processor, a parameter gamma Γ which expresses a dependence of the parameter delta Δ on the one or more underlyings Fⱼ for j=1 . . . M, wherein determining the parameter gamma Γ comprises applying, by the processor, a finite difference technique using the full set of AD sensitivities \vec{∇}V of the expected value of the financial contract.

15. A method according to claim 3 further comprising determining, by the processor, a parameter gamma Γ which expresses a dependence of the parameter delta Δ on the one or more underlyings Fⱼ for j=1 . . . M, wherein determining the parameter gamma Γ comprises applying, by the processor, a finite difference technique using the full set of AD sensitivities \vec{∇}V of the expected value of the financial contract and wherein applying the finite difference technique using the full set of AD sensitivities \vec{∇}V of the expected value of the financial contract comprises:
forming, by the processor, a computer representation of a displaced market vector \vec{a}′ according to \vec{a}′=\vec{a}+δa\vec{e}_{Δ} where \vec{a} is an original market vector, δa is a finite difference magnitude and \vec{e}_{Δ} is a unit vector having a direction of the reprojected sensitivity vector J^{T}
$$\vec{Δ} = {\sum }_{j = 1}^{M} {Δ}_{j} \vec{∇} {F}_{j} ( {\vec{e}}_{Δ} = \frac{{J}^{T} \vec{Δ}}{\vert {J}^{T} \vec{Δ} \vert} ≡ \frac{{\sum }_{j = 1}^{M} {Δ}_{j} \vec{∇} {F}_{j}}{\vert {\sum }_{j = 1}^{M} {Δ}_{j} \vec{∇} {F}_{j} \vert} ) ;$$
determining, by the processor, the parameter delta Δ for the expected value of the financial contract at both the original market vector \vec{a} and for the displaced market vector \vec{a}′;
determining, by the processor, the parameter gamma Γ according to
$$Γ \approx \frac{1}{δ a} ( Δ ( \vec{a} + δ a \vec{{e}_{Δ}} ) - Δ ( \vec{a} ) ) .$$

16. A method according to claim 4 wherein determining the parameter delta Δ from the computer representation of the reprojected sensitivity vectors comprises determining, by the processor, the parameter delta Δ in accordance with Δ=Σⱼ₌₁^{M}Δⱼ.

17. A method according to claim 4 comprising determining, by the processor, a direction of the reprojected sensitivity vector J^{T}\vec{Δ}=Σⱼ₌₁^{M}Δⱼ\vec{∇}Fⱼ.

18. A method according to claim 1 wherein some or all of the steps are performed by one or more suitably configured processors.

19. A system for determining a parameter delta Δ which expresses a dependence of an expected value V of a financial contract on one or more underlyings of the financial contract, the system comprising a processor configured, by execution of suitable software, to:
obtain a computer representation of a complete set of algorithmic differentiation (AD) sensitivities of the expected value V of the financial contract to a set of N input parameters \vec{a} in a form
$$\vec{∇} V = {[ \frac{\partial V}{\partial {a}_{1}} , \frac{\partial V}{\partial {a}_{2}} , … \frac{\partial V}{\partial {a}_{N}} ]}^{T}$$
or a mathematical equivalent thereof;
obtain a computer representation of a complete set of AD sensitivities of the expected value of the one or more underlyings Fⱼ for j=1 . . . M, where M<N and M is a number of the one or more underlyings, to the set of N input parameters \vec{a} in a form
$$\vec{∇} {F}_{j} = {[ \frac{\partial {F}_{j}}{\partial {a}_{1}} , \frac{\partial {F}_{j}}{\partial {a}_{2}} , … \frac{\partial {F}_{j}}{\partial {a}_{N}} ]}^{T}$$
for each j=1 . . . M or a mathematical equivalent thereof;
reproject the full set of AD sensitivities \vec{∇}V of the expected value of the financial contract onto the full set of AD sensitivities \vec{∇}Fⱼ for j=1 . . . M of the one or more underlyings to obtain a computer representation of reprojected sensitivity vectors; and
determine the parameter delta Δ based on the computer representation of the reprojected sensitivity vectors.

20. A computer program product comprising a non-transitory computer-readable medium having instructions stored thereon, the instructions, when executed by a processor causing the processor to perform the method of claim 1.
